(19) United States
(12) Patent Application Publication
(10) Pub. No.: US 2026/0367774 A1
(43) Pub. Date: Nov. 19, 2026

(54) Interaction Processing Method and Apparatus for Virtual Scene, Electronic Device, Computer-Readable Storage Medium, and Computer Program Product

(71) Applicant: Tencent Technology (Shenzhen)Company Limited, Shenzhen (CN)

(72) Inventor: Jing Zhou, Shenzhen (CN)

(21) Appl. No.: 19/731,293

(22) Filed: Jul. 6, 2026

Related U.S. Application Data
(63) Continuation of application No. PCT/CN2025/107702, filed on Jul. 9, 2025.

(30) Foreign Application Priority Data
Aug. 13, 2024 (CN) 2024111102996

(51) Int. Cl. G06F 3/04845; A63F 13/837; G06F 3/04847

(52) U.S. Cl. CPC G06F 3/04845; A63F 13/837; G06F 3/04847

(57) ABSTRACT

An interaction processing method for a virtual scene comprises: displaying a first virtual scene picture, the first virtual scene picture being obtained by a virtual object observing a virtual scene from a first viewing angle; and in response to a viewing angle rotation operation indicating a direction, keeping the body of the virtual object from rotating, and controlling the head of the virtual object to rotate by a corresponding angle in the direction indicated by the viewing angle rotation operation. The method also comprises switching to displaying a second virtual scene picture. The second virtual scene picture is obtained by the virtual object observing the virtual scene from a second viewing angle. The second viewing angle corresponds to the head of the virtual object after the head of the virtual object is rotated.

### RELATED APPLICATIONS

This application claims priority to PCT/CN2025/107702, filed on Jul. 9, 2025, which claims priority to Chinese Patent Application No. 2024111102996, filed on Aug. 13, 2024, each of which is incorporated by reference in its entirety.

### FIELD OF THE TECHNOLOGY

This application relates to the field of Internet technologies, and in particular, to an interaction processing method and apparatus for a virtual scene, an electronic device, a computer-readable storage medium, and a computer program product.

### BACKGROUND OF THE DISCLOSURE

A display technology based on graphics processing hardware has expanded channels for perceiving the environment and obtaining information. Especially, a display technology for a virtual scene can implement diversified interactions between virtual objects controlled by users (which are also referred to as players) or artificial intelligence according to actual application requirements, and has various typical application scenarios, such as simulating a realistic battle process between virtual objects in a virtual scene of a game. A shooting game is used as an example. A player can view a surrounding situation by controlling a game character to turn around.

### SUMMARY

Aspects of this disclosure provide an interaction processing method and apparatus for a virtual scene, an electronic device, a computer-readable storage medium, and a computer program product, to enable a player to obtain surrounding information without producing any sound. This enriches strategic depth of a game, and further enhances game experience of the player.

Technical solutions described herein are implemented as follows: Described herein is an interaction processing method for a virtual scene, applied to an electronic device and including: displaying a first virtual scene picture, the first virtual scene picture being obtained by a virtual object observing a virtual scene from a first viewing angle; in response to a viewing angle rotation operation indicating a direction, keeping the body of the virtual object from rotating, and controlling a head of the virtual object to rotate by a corresponding angle in the direction indicated by the viewing angle rotation operation; and switching to displaying a second virtual scene picture, the second virtual scene picture being obtained by the virtual object observing the virtual scene from a second viewing angle, and the second viewing angle corresponding to the head of the virtual object after the head of the virtual object is rotated.

Described herein is an interaction processing apparatus for a virtual scene, including: a display module, configured to display a first virtual scene picture, the first virtual scene picture being obtained by a virtual object observing a virtual scene from a first viewing angle; and a control module, configured to in response to a viewing angle rotation operation indicating a direction, keep the body of the virtual object from rotating, and control a head of the virtual object to rotate by a corresponding angle in the direction indicated by the viewing angle rotation operation; and the display module being further configured to switch to displaying a second virtual scene picture, the second virtual scene picture being obtained by the virtual object observing the virtual scene from a second viewing angle, and the second viewing angle corresponding to the head of the virtual object after the head of the virtual object is rotated.

Described herein is an electronic device, including: a memory, configured to store executable instructions; and a processor, configured to implement the interaction processing method for a virtual scene described herein when executing the executable instructions stored in the memory.

Described herein is a computer-readable storage medium, having computer-executable instructions stored therein. The computer-executable instructions, when executed by a processor, implement the interaction processing method for a virtual scene described herein.

Described herein is a computer program product, including a computer program or computer-executable instructions. The computer program or the computer-executable instructions, when executed by a processor, implement the interaction processing method for a virtual scene described herein.

The aspects described herein have the following beneficial effects: When the viewing angle rotation operation triggered by the player is received, surrounding information is obtained by rotating only the head of the virtual object without rotating the body. Because a range of motion of head rotation is small, no sound may be produced or output. This avoids a sound effect generated by body rotation from exposing a position of the player. In this way, a silent observation method is provided for the player, which allows the player to choose to obtain surrounding information without producing any sound to potentially expose himself/herself. This enriches tactical options in the virtual scene and enhances the game experience of the player.

### BRIEF DESCRIPTION OF THE DRAWINGS

FIG. 1 is a schematic diagram of an architecture of an interaction processing system 100 for a virtual scene according to an example.

FIG. 2 is a schematic structural diagram of an electronic device 500 according to an example.

FIG. 3 is a first schematic flowchart of an interaction processing method for a virtual scene according to an example.

FIG. 4 is a second schematic flowchart of an interaction processing method for a virtual scene according to an example.

FIG. 5 is a schematic diagram of a first application scenario of an interaction processing method for a virtual scene according to an example.

FIG. 6 is a schematic diagram of a second application scenario of an interaction processing method for a virtual scene according to an example.

FIG. 7A is a schematic diagram of a third application scenario of an interaction processing method for a virtual scene according to an example.

FIG. 7B is a schematic diagram of a fourth application scenario of an interaction processing method for a virtual scene according to an example.

FIG. 8A is a schematic diagram of a fifth application scenario of an interaction processing method for a virtual scene according to an example.

FIG. 8B is a schematic diagram of a sixth application scenario of an interaction processing method for a virtual scene according to an example.

FIG. 9 is a schematic diagram of comparison between rotating the body for observation and rotating the head for observation according to an example.

FIG. 10 is a schematic diagram of a seventh application scenario of an interaction processing method for a virtual scene according to an example.

FIG. 11 is a third schematic flowchart of an interaction processing method for a virtual scene according to an example.

FIG. 12 is a first schematic diagram of a setting interface according to an example.

FIG. 13 is a schematic diagram of an angle limitation interface according to an example.

FIG. 14 is a second schematic diagram of a setting interface according to an example.

FIG. 15 is a schematic diagram of a direction control according to an example.

FIG. 16 is a schematic diagram of a local Euler angle according to an example.

The terms “first” and “second” are only used to distinguish different solutions, and do not indicate the degree of superiority of the solution or priority in implementation.

### DETAILED DESCRIPTION

To make the objectives, technical solutions, and advantages of this application clearer, the following further describes this application in detail with reference to the accompanying drawings. The described examples are not to be considered as a limitation on this application. All other examples obtained by a person of ordinary skill in the art without creative efforts fall within the scope of protection of this application.

The term “some examples” involved in the following description describes a subset of all possible examples. However, the term “some examples” may refer to a same subset or different subsets of all the possible examples, and may be combined with each other without conflict.

In examples described herein, related data (such as data of a game character controlled by a player), such as user information, is involved. When the examples described herein are applied to a specific product or technology, permission or consent of a user is required, and collection, use, and processing of the related data need to comply with the relevant laws, regulations, and standards.

In the following description, the terms “first/second/third . . . ” are merely used to distinguish between similar objects and do not indicate a specific sequence of the objects. A specific order or sequence of the “first/second/third . . . ” may be interchanged if permitted. In this way, the examples described herein may be implemented in an order other than the order illustrated or described herein.

Unless otherwise defined, all technical and scientific terms used herein have the same meanings as commonly understood by those skilled in the art to which this application belongs. The terms are used herein for the purpose of describing the examples only and are not intended to limit this application.

Before the examples herein are further described in detail, nouns and terms involved in the examples are described. The nouns and terms involved in the examples are subject to the following explanations.

(1) “In response to”: it represents a condition or state on which a to-be-performed operation depends. When the condition or state is satisfied, one or more operations may be performed in real time or after a set delay. Unless otherwise specified, there is no limitation on the order in which the plurality of operations are performed.

(2) Virtual scene: it is a scene displayed (or provided) when an application (APP) runs on a terminal device. The scene may be a simulated environment for a real world, or may be a semi-simulated and semi-fictional virtual environment, or may be a purely fictional virtual environment. The virtual scene may be any one of a two-dimensional virtual scene, a 2.5-dimensional virtual scene, and a three-dimensional virtual scene. The dimension of the virtual scene is not limited herein. For example, the virtual scene may include a sky, a land, an ocean, and the like. The land includes environmental elements such as a desert and a city. A user can control a virtual object to move in the virtual scene.

(3) Virtual object: it refers to a representation of a person or an item that can perform interaction in a virtual scene, or a movable object in a virtual scene. The movable object may be a virtual human, a virtual animal, an animated human, or the like, such as a human or an animal displayed in a virtual scene. For example, the virtual object may be a virtual representation configured to represent a user in the virtual scene. A plurality of virtual objects may be included in the virtual scene. Each virtual object has its own shape and volume in the virtual scene, and occupies a portion of the space in the virtual scene.

(4) Cloud gaming: it is also referred to as gaming on demand, and refers to a game program deployed on a server, where an instance of the game program (referred to as a game instance) is executed. The game instance transmits game data outputted during operation to a page of a browser of a user terminal. The page invokes a media component of the browser to decode the game data, and renders a real-time game picture of a game process based on a decoding result. When monitoring an operation performed by a user in the game picture, the page reports to the game instance running on the server, and repeats the decoding and rendering process when receives game data generated by the game instance in response to an operation. In this way, a change of the game picture that is caused by the operation of the user is presented on the page.

In other words, cloud gaming is an online gaming technology based on a cloud computing technology. The cloud gaming technology enables a thin client with limited graphics processing and data computing capabilities to run a high-quality game. In a cloud gaming scenario, the game does not run on the user terminal (such as a game terminal of a player), but rather runs on a cloud server. The cloud server renders a game scene into an audio-video stream, and transmits the audio-video stream to the user terminal over a network. In this way, the user terminal does not need to have powerful graphics computing and data processing capabilities, but only needs to have a basic streaming media playback capability and a capability to obtain an instruction inputted by the player and transmit the instruction to the cloud server.

(5) Machine learning model: it is a data-driven algorithm model whose core mechanism is to perform learning based on a large amount of sample data, to mine implicit patterns, regularities, or relationships within the data, and then perform prediction, classification, or decision-making on new input data based on the learning. The machine learning model may employ an algorithm architecture such as a convolutional neural network (CNN), a recurrent neural network (RNN), or a support vector machine (SVM), and optimize parameters through data learning to adapt to dynamically changing interaction requirements in a virtual scene.

A shooting game is used as an example. In the realistic shooting game, a player can determine information (namely, a position) about an opponent through a sound. In the related art, when the player controls a game character to rotate the body and observe a surrounding situation, because a range of motion of body rotation is large, the game character inevitably produces sounds during body rotation, which exposes the game character.

In view of this, described herein are an interaction processing method and apparatus for a virtual scene, an electronic device, a computer-readable storage medium, and a computer program product, to enable a player to obtain surrounding information without producing any sound that exposes the player. The following describes the electronic device provided in the examples herein. The electronic device provided in the examples herein may be implemented as a terminal device (which corresponds to a single-player game), or collaboratively implemented by a terminal device and a server (which corresponds to an online game). A description is made below by using an example in which a server and a terminal device collaboratively implement the interaction processing method for a virtual scene described herein.

Before an architecture of an interaction processing system for a virtual scene described herein is described, a game mode involved in the examples is described. The solution collaboratively implemented by the terminal device and the server mainly involves two game modes, which are a local game mode and a cloud game mode, respectively. The local game mode means that the terminal device and the server collaboratively run a game processing logic. One part of operation instructions inputted by the player into the terminal device are processed by the terminal device running the game logic, and the other part is processed by the server running the game logic. In addition, the game processing logic run by the server is often more complex and requires greater computing power. The cloud game mode means that the server (such as a cloud server) completely runs a game processing logic. The cloud server renders game scene data into an audio-video stream, and then transmits the audio-video stream to the terminal device over a network for display. In other words, the terminal device only needs to have a basic streaming media playback capability and a capability to obtain an operation instruction of a player and transmit the operation instruction to the server.

The following describes the architecture of the interaction processing system for a virtual scene according to the examples herein.

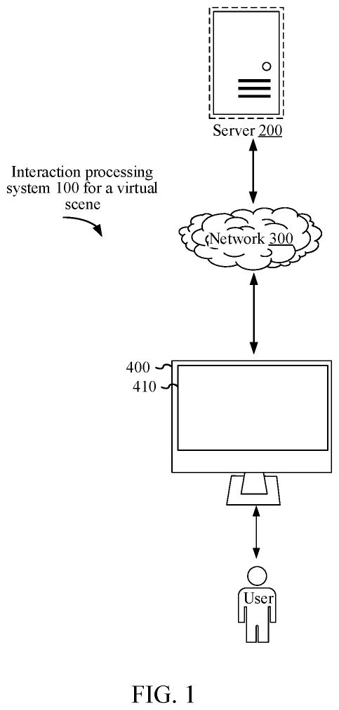

For example, FIG. 1 is a schematic diagram of an architecture of an interaction processing system 100 for a virtual scene according to an example. As shown in FIG. 1, the interaction processing system 100 for a virtual scene includes: a server 200, a network 300, and a terminal device 400. The server 200 is a backend server of a client 410 running on the terminal device 400. The network 300 may be a local area network, a wide area network, or a combination thereof. The terminal device 400 is a terminal device associated with a user (or referred to as a player). The client 410 runs on the terminal device 400. The client 410 may be any type of client, for example, including a shooting game client, a role-playing game client, and a browser.

In some examples, a shooting game is used as an example. A first virtual scene picture may be displayed on a human-computer interaction interface of the client 410. The first virtual scene picture may be obtained by a virtual object (such as a game character A) controlled by the user observing a virtual scene from a first viewing angle (such as a current viewing angle). Then, when receiving a viewing angle rotation operation triggered by the user, the client 410 may keep, in response to the viewing angle rotation operation, the body (namely the torso and four limbs) of the virtual object from rotation, control the head of the virtual object to rotate by a corresponding angle in a direction indicated by the viewing angle rotation operation, and switch displaying from the first virtual scene picture to a second virtual scene picture. The second virtual scene picture is obtained by the virtual object observing the virtual scene from a second viewing angle, and the second viewing angle is a viewing angle corresponding to the head of the virtual object after the head of the virtual object is rotated. In this way, the player can obtain surrounding information without producing any sound that exposes the player. This enriches strategic depth of a game, and further enhances game experience of the player.

In the interaction processing method for a virtual scene described herein, the virtual scene may be completely outputted based on the terminal device, or collaboratively outputted based on the terminal device and the server. For example, completion of related data computation and output of the virtual scene may entirely rely on a computing capability of graphics processing hardware of the terminal device 400. A type of the graphics processing hardware includes a central processing unit (CPU) and a graphics processing unit (GPU). For example, when forming a visual perception of the virtual scene, the terminal device 400 computes data required for display through the graphics computing hardware, completes loading, parsing, and rendering of the display data, and outputs video frames that enable visual perception of the virtual scene through graphics output hardware. For example, a two-dimensional video frame is presented on a display screen of a smartphone, or a video frame that achieves a three-dimensional display effect is projected onto lenses of augmented reality/virtual reality glasses. In addition, to enrich a perception effect, the terminal device 400 may further form one or more of an auditory perception, a tactile perception, a motion perception, and a taste perception through different hardware.

Additionally or alternatively, completion of virtual scene computation may rely on a computing capability of the server 200, and the virtual scene is outputted through the terminal device 400. Formation of a visual perception of the virtual scene is used as an example. The server 200 computes related display data (such as scene data) of the virtual scene and transmits the display data to the terminal device 400 over the network 300. The terminal device 400 completes loading, parsing, and rendering the computed display data through the graphics computing hardware, and outputs the virtual scene through the graphics output hardware to form the visual perception. For example, a two-dimensional video frame may be presented on a display screen of a smartphone, or a video frame that achieves a three-dimensional display effect is projected onto lenses of augmented reality/virtual reality glasses. As for the perception of the form of the virtual scene, it can be formed through corresponding hardware output of the terminal device 400. For example, the auditory perception is formed through a microphone, or the tactile perception is formed through a vibrator.

In addition, the server 200 in FIG. 1 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 400 may be, but is not limited thereto, a smartphone, a tablet computer, a laptop computer, a desktop computer, a smart speaker, a smartwatch, an in-vehicle terminal, and the like. The terminal device 400 and the server 200 may be directly or indirectly connected by using a wired or wireless communication protocol. This is not limited herein.

In some other examples, the terminal device or the server may implement the interaction processing method for a virtual scene described herein by running various computer-executable instructions or a computer program. For example, the computer-executable instructions may be microprogram-level commands, machine instructions, or software instructions. The computer program may be a native program or software module in an operating system; may be a native APP, namely a program that needs to be installed in the operating system to run, such as a shooting game APP; or may be a mini program that can be embedded into any APP, namely, a program that only needs to be downloaded into a browser environment to run. To sum up, the foregoing computer-executable instructions may be instructions in any form, and the foregoing computer program may be an APP, a module, or a plug-in in any form.

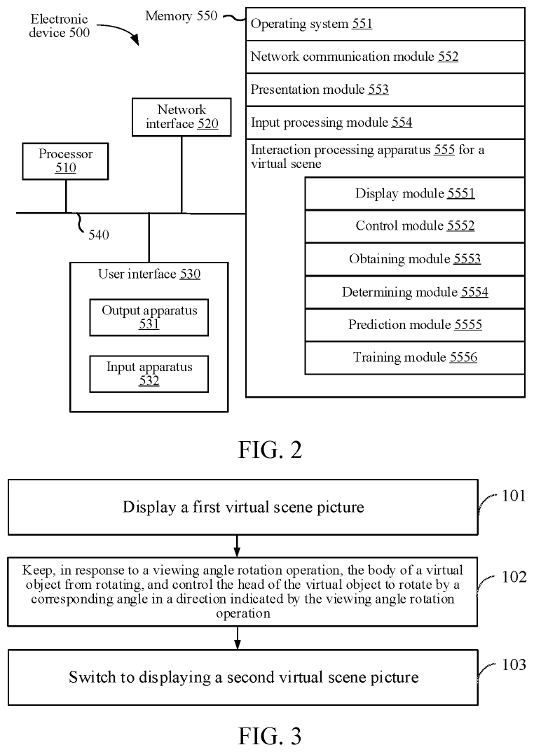

The following continues to describe a structure of an electronic device provided in the examples herein. An example in which the electronic device is a terminal device is used. FIG. 2 is a schematic structural diagram of an electronic device 500 according to an example. The electronic device 500 shown in FIG. 2 includes: at least one processor 510, a memory 550, at least one network interface 520, and a user interface 530. All components in the electronic device 500 are coupled together via a bus system 540. The bus system 540 is configured to implement connection communication between the components. In addition to including a data bus, the bus system 540 further includes a power bus, a control bus, and a status signal bus. However, for clear description, all types of buses are marked as the bus system 540 in FIG. 2.

The processor 510 may be an integrated circuit chip having a signal processing capability, such as a general-purpose processor, a digital signal processor (DSP), or another programmable logic device, discrete gate or transistor logical device, or discrete hardware component. The general-purpose processor may be a microprocessor, any conventional processor, or the like.

The user interface 530 includes one or more output apparatuses 531 that enable presentation of media content, including one or more loudspeakers and/or one or more visual display screens. The user interface 530 further includes one or more input apparatuses 532, including a user interface component that facilitate user input, such as a keyboard, a mouse, a microphone, a touch display screen, a camera, another input button, and a control.

The memory 550 is removable memory, a non-removable memory, or a combination thereof. Exemplary hardware devices include a solid-state memory, a hard disk drive, an optical disk drive, and the like. In an example, the memory 550 includes one or more storage devices that are physically remote from the processor 510.

The memory 550 includes a volatile memory or a non-volatile memory, or may include both a volatile memory and a non-volatile memory. The non-volatile memory may be a read-only memory (ROM), and the volatile memory may be a random-access memory (RAM). The memory 550 described herein is intended to include any suitable type of memory.

In some examples, the memory 550 can store data to support various operations. Examples of the data include a program, a module, and a data structure, or a subset or a superset thereof. An exemplary description is made below.

An operating system 551 includes a system program configured to process various basic system services and perform hardware-related tasks, such as a framework layer, a core library layer, and a driver layer that are configured to implement various basic services and process hardware-based tasks.

A network communication module 552 is configured to connect to another computing device via one or more (wired or wireless) network interfaces 520. Exemplary network interfaces 520 include Bluetooth, wireless fidelity (Wi-Fi), universal serial bus (USB), and the like.

A presentation module 553 is configured to present information through one or more output apparatuses 531 (such as a display screen and a loudspeaker) associated with the user interface 530 (such as a user interface configured to operate a peripheral device and display content and information).

An input processing module 554 is configured to detect one or more user inputs or interactions from one of one or more input apparatuses 532 and translate the detected input or interaction.

In some examples, the apparatus provided herein may be implemented in the form of software. FIG. 2 shows an interaction processing apparatus 555 for a virtual scene that is stored in the memory 550, which may be software in the form of a program and a plug-in, and includes the following software modules: a display module 5551, a control module 5552, an obtaining module 5553, a determining module 5554, a prediction module 5555, a training module 5556. These modules are logical, and may be combined or further split in different manners according to functions to be implemented. For ease of expression, all the foregoing modules are shown at once in FIG. 2. However, it is not to be regarded as excluding an implementation in which the interaction processing apparatus 555 for a virtual scene may only include the display module 5551 and the control module 5552. Functions of the modules are described below.

The following describes the interaction processing method for a virtual scene described herein in detail with reference to exemplary application and implementations of the terminal device provided in the examples herein.

FIG. 3 is a first schematic flowchart of an interaction method for a virtual scene according to an example. A description is made with reference to operations shown in FIG. 3.

The method shown in FIG. 3 may be performed through various forms of computer programs run on a terminal device, which is not limited to a client, and for example, may alternatively be the operating system, the software module, the script, and the mini program that are described above. Therefore, the following description that is made by taking the client as an example is not intended to limit the examples herein. In addition, for ease of expression, the following text does not make a specific distinction between the terminal device and the client run on the terminal device.

Operation 101: Display a first virtual scene picture.

Herein, the first virtual scene picture may be obtained by a virtual object (such as a game character A controlled by a current player in a game scene) observing a virtual scene from a first viewing angle (such as a current viewing angle). For example, a virtual camera corresponding to the virtual object may be set in the virtual scene, and the virtual camera is controlled to capture the virtual scene from the first viewing angle, to obtain the first virtual scene picture.

An example in which the virtual object is the game character A controlled by the current player is used. A virtual camera corresponding to the game character A may be set in the game scene (namely, the virtual scene) in which the game character A is located. For example, when the first-person perspective is used, the virtual camera may be set near the head of the game character A (such as a position of the eyes of the game character A). The virtual camera is used to capture the game scene, to obtain a corresponding game scene picture (namely, the first virtual scene picture). A viewing angle of the virtual camera is the same as a viewing angle of the game character A. The virtual camera may be used as the eyes of the game character A to capture the game scene, to obtain the corresponding game scene picture. In addition, when the third-person perspective is used, the virtual camera may be set behind the game character A and bound to the game character A. To be specific, when the game character A moves in the game scene, the virtual camera moves with the game character A. In addition, the virtual camera is not actually displayed in the game scene, that is, the player cannot recognize the virtual camera bound to the game character A from the game scene.

The player may control the virtual object in the virtual scene to perform an activity. The activity includes, but is not limited to, at least one of adjusting a body posture, crawling, walking, running, riding, jumping, driving, picking, shooting, attacking, or throwing. The virtual object may be a simulated human character, an animated human character, or the like. In addition, in addition to the virtual object (such as the game character A) controlled by the current player, a virtual object (such as a game character B) controlled by another player or artificial intelligence may further be displayed in the virtual scene. The game character A and the game character B may belong to a same faction. To be specific, the game character A and the game character B are in a cooperative relationship and jointly perform a certain task. Alternatively, the game character A and the game character B may belong to different factions. To be specific, the game character A and the game character B are in a mutually adversarial and hostile relationship.

In some examples, a shooting game is used as an example. The virtual object controlled by the current player may be displayed in the virtual scene. The virtual object may hold a virtual shooting prop (such as a virtual firearm). The first virtual scene picture is obtained by the virtual object observing the virtual scene from the first viewing angle, for example, may be a picture displayed from the first-person perspective of the virtual object (namely, a picture obtained by capturing the virtual scene by using the virtual camera set near the head of the virtual object), or may be a picture displayed from the third-person perspective of the virtual object (namely, a picture obtained by capturing the virtual scene by using the virtual camera set behind the virtual object). Various controls may further be superimposed on the first virtual scene picture, for example, including at least one of a movement control, a shooting control, a throwing control, a small map control, and a map orientation guidance control. The player may click/tap a corresponding control to control the virtual object to perform a corresponding action.

Operation 102: Keep, in response to a viewing angle rotation operation, the body of the virtual object from rotating, and control the head of the virtual object to rotate by a corresponding angle in a direction indicated by the viewing angle rotation operation.

Herein, the body of the virtual object specifically refers to the torso and limbs of the virtual object. In addition, the angle by which the head of the virtual object is rotated may be related to the viewing angle rotation operation. For example, when the viewing angle rotation operation is a movement operation (including a slide operation for a touchscreen, a drag operation for a mouse, and the like), an angle by which the head of the virtual object is to be rotated may be determined based on a movement distance of the movement operation. When the viewing angle rotation operation is a press operation for a direction control, an angle by which the head of the virtual object is to be rotated may be determined based on a press force of the press operation. Alternatively, the viewing angle rotation operation may be configured to determine a rotation direction of the head of the virtual object only, and an angle by which the head of the virtual object is to be rotated may be automatically determined through artificial intelligence. This is specifically described below.

For example, when the player triggers the viewing angle rotation operation (such as dragging a mouse, sliding a screen, or pressing a direction control) in the virtual scene, the direction (such as left, right, up, or down) indicated by the viewing angle rotation operation is identified, the angle by which the head is to be rotated is calculated based on an operation parameter (such as a movement distance or a press force), and finally, only the head of the virtual object is controlled to rotate in the direction by the corresponding angle, and body parts, such as the torso and four limbs, are kept stationary.

For example, in the virtual scene, calculating the angle by which the head is to be rotated and controlling the head of the virtual object to rotate by the corresponding angle in the direction indicated by the viewing angle rotation operation may be implemented through collaborative transformation between a world coordinate system and a local coordinate system. For example, when the viewing angle rotation operation is a movement operation (the player drags a mouse), first, a mouse drag distance is mapped to an angular increment. An angular direction herein is based on the world coordinate system. Horizontal dragging corresponds to a yaw angle (yaw) around the Z axis of the world coordinate system, and vertical sliding corresponds to a pitch angle (pitch) around the Y axis of the world coordinate system. When the player drags the mouse upward by 1 centimeter, it is assumed that 1 centimeter corresponds to a 10-degree rotation. In this case, a pitch angle increment of 10 degrees is generated (correspondingly, when the player drags the mouse downward by 1 centimeter, a pitch angle increment of −10 degrees is generated). Next, a rotation state of the head relative to the torso (such as, the midpoint of the thorax) is represented by a local Euler angle of the head. It is assumed that a current local Euler angle of the head is (20°, 10°, 0°), a newly added horizontal increment of 10° is superimposed onto a pitch angle corresponding to the Y axis of the local coordinate system, to obtain a new angle (20°, 20°, 0°). It is assumed that the torso faces a positive direction of the X axis of the world coordinate system, because the torso does not rotate relative to the world coordinate system (that is, axes of the local coordinate system does not deflect relative to the world coordinate system), an axis direction of the local coordinate system is the same as that of the world coordinate system. In this case, the new angle (20°, 20°, 0°) corresponds to a composite rotation in the world coordinate system that includes a yaw of 20° around the Z-axis and a pitch of 20° around the Y-axis, which is visually represented as the head pointing in the direction of 20° to the right and 20° upward.

The world coordinate system refers to a global reference framework of the virtual scene, which uses a fixed origin as a reference (such as a (0, 0, 0) point at the center of the virtual scene). Coordinate axis directions may be fixed as that the X axis points to the front of the scene (that is, pointing from the interior of a screen toward the exterior), the Z axis points vertically upward, and the Y axis points horizontally to the right. Absolute positions and global directions of all items in the virtual scene are calculated based on this reference.

The local coordinate system refers to a reference system attached to the torso of the virtual object, which may use the midpoint of the thorax of the torso as an origin. Coordinate axis direction are determined based on an orientation of the torso. For example, the X axis points to the front of the torso, the Z axis points vertically upward (consistent with the direction of the Z axis of the world coordinate system), and the Y axis points to the right of the torso. When the torso moves or rotates in the world space, the local coordinate system transforms synchronously with the torso, but the rotation of the head is calculated as a relative rotation merely based on the local coordinate system.

The local Euler angle refers to a rotation angle of the head relative to a local coordinate system of the torso. FIG. 16 is a schematic diagram of a local Euler angle according to an example. The local Euler angle is represented by three dimensions (Yaw, Pitch, Roll). Yaw denotes a yaw angle (controlling the head to rotate to the left and right) around the Z axis of the local coordinate system, Pitch denotes a pitch angle (controlling the head to move up and down) around the Y axis of the local coordinate system, and Roll denotes a roll angle (typically being 0) around the X axis of the local coordinate system. In the foregoing example, the local Euler angle (20°, 20°, 0°) of the head represents a state in which the head is “rotated by 20° to the right, pitched up 20°, and without roll (Roll is 0°)” relative to the torso.

For example, when the terminal device is a desktop computer or a laptop portable notebook computer, the viewing angle rotation operation may be an input operation based on an external input device. For example, an operation of the player pressing and holding a middle mouse button and dragging a mouse may be identified as a viewing angle rotation operation, or a press operation performed by the player for a specific key on a keyboard may be identified as a viewing angle rotation operation, or a shaking operation performed by the player for a handle may be identified as a viewing angle rotation operation. When the terminal device is a mobile terminal such as a mobile phone or a tablet computer, a trigger operation of the player for a particular virtual control displayed on a touchscreen may be identified as a viewing angle rotation operation, or a slide operation for the touchscreen may be identified as a viewing angle rotation operation. This is not specifically limited herein.

In some examples, the viewing angle rotation operation may be a movement operation (which may be, for example, an operation of pressing and holding a middle mouse button and dragging a mouse). In this case, the controlling the head of the virtual object to rotate by the corresponding angle in the direction indicated by the viewing angle rotation operation may be implemented in the following manner: obtaining a movement distance of the movement operation; and determining, based on the movement distance, an angle by which the head of the virtual object is to be rotated, the angle by which the head of the virtual object is to be rotated being positively correlated with the movement distance (to be specific, a longer movement distance indicates a larger angle by which the head of the virtual object is to be rotated); and controlling the head of the virtual object to rotate by the determined angle in a movement direction of the movement operation (namely, the direction indicated by the viewing angle rotation operation).

For example, the determining, based on the movement distance, the angle by which the head of the virtual object is to be rotated may be implemented in the following manner: querying a pre-created mapping table based on the movement distance when the movement distance is less than a distance threshold (such as 3 centimeters), to obtain an angle corresponding to the movement distance, and using the angle as the angle by which the head of the virtual object is to be rotated, the mapping table including mapping relationships between different movement distances and different angles; or using, when the movement distance is greater than the distance threshold, a preset maximum rotatable angle (for example, 80 degrees) as the angle by which the head of the virtual object is to be rotated. This can avoid clipping caused by an excessively large rotation angle of the head of the virtual object.

An example in which the terminal device is a desktop computer is used. When it is detected that the player presses and holds a middle mouse button (namely, a mouse wheel) and drags a mouse to the right, a distance by which the player drags the mouse may be obtained. A pre-created mapping table is queried based on the distance, to obtain an angle corresponding to the distance. For example, it is assumed that the distance by which the player drags the mouse is 1 centimeter, and by querying the mapping table, it is learned that an angle corresponding to 1 centimeter is 15 degrees. In this case, 15 degrees may be used as an angle by which the head of the virtual object is to be rotated. Finally, the head of the virtual object may be controlled to rotate by 15 degrees to the right. In addition, when it is detected that the distance (which may be, for example, 5 centimeters) by which the player drags the mouse exceeds the distance threshold, that is, an angle corresponding to the distance cannot be found from the mapping table, a preset maximum rotatable angle (which may be, for example, 90 degrees) corresponding to the right direction may be used as an angle by which the head of the virtual object is to be rotated. In other words, a rotation angle of the head of the virtual object is limited. Even if the distance by which the player drags the mouse to the right is greater than the distance threshold, the head of the virtual object is controlled to rotate by only 90 degrees to the right. This can avoid clipping caused by an excessively large rotation angle of the head of the virtual object.

An example in which the terminal device is a mobile phone is used. When it is detected that the player slides a screen to the left, a distance by which the player slides the screen to the left may be obtained. A pre-created mapping table is queried based on the distance, to obtain an angle corresponding to the distance. For example, it is assumed that the distance by which the player slides the screen to the left is 2 centimeters, and an angle (which may be, for example, 20 degrees) corresponding to 2 centimeters in the mapping table may be used as an angle by which the head of the virtual object is to be rotated. Then, the head of the virtual object may be controlled to rotate by 20 degrees to the left while keeping the body of the virtual object from rotating, to view a situation on the left of the virtual object. In addition, if it is detected that the distance by which the player slides the screen is greater than the distance threshold, that is, an angle corresponding to the distance cannot be found from the mapping table, a preset maximum rotatable angle (such as 90 degrees) corresponding to the left direction may be used as an angle by which the head of the virtual object is to be rotated. In other words, when it is detected that the distance by which the player slides the screen to the left is greater than the distance threshold, the head of the virtual object is controlled to rotate by only 90 degrees to the left. This can avoid clipping caused by an excessively large rotation angle of the head of the virtual object.

In the examples described herein, the rotation angle of the head of the virtual object is dynamically controlled based on the movement distance. This achieves a positive correlation between the operation precision and the movement distance (for example, 1 centimeter of movement corresponds to 15 degrees of rotation), to enable the player to finely adjust the viewing angle through delicate mouse dragging or screen sliding. In addition, a dual limitation including the distance threshold (such as 5 centimeter) and the maximum rotatable angle (such as 90 degrees) is used to effectively avoid clipping caused by excessive dragging. This enhances visual realism of the virtual scene.

In some other examples, at least one direction control may be displayed in the virtual scene, and the viewing angle rotation operation may be a press operation for any direction control. In this case, the controlling the head of the virtual object to rotate by a corresponding angle in a direction indicated by the viewing angle rotation operation may be implemented in the following manner: obtaining press parameters of the press operation; determining, based on the press parameters, the angle by which the head of the virtual object is to be rotated; and controlling the head of the virtual object to rotate by the determined angle in a direction indicated by the pressed direction control.

The direction control configured to control a rotation direction of the head of the virtual object and a direction control configured to control a movement direction of the virtual object may be a same set of direction controls. That is, the direction control may have two different modes. For example, in a first mode, the direction control is configured to control a movement direction of the virtual object. In a second mode, the direction control is configured to control a rotation direction of the head of the virtual object. In addition, to facilitate differentiation by the player, the direction control may have different display styles in different modes. For example, in the first mode, the direction control may be red, and in the second mode, the direction control may be green. Alternatively, when the direction control is in the first mode, first prompt information may be displayed near the direction control. The first prompt information is configured to prompt that the direction control is configured to control a movement direction of the virtual object. When the direction control is in the second mode, second prompt information may be displayed near the direction control. The second prompt information is configured to prompt that the direction control is configured to control a rotation direction of the head of the virtual object. This is not specifically limited herein.

In addition, mode switching of the direction control may be implemented by triggering a mode switching control. For example, the mode switching control may be displayed near the direction control, and the player may click/tap the mode switching control to implement mode switching. For example, it is assumed that the direction control is currently in the first mode, and the player intends to rotate the head of the virtual object to view situations around at this time. In this case, the player may click/tap the mode switching control. After a clicking/tapping operation of the player for the mode switching control is received, the mode of the direction control may be switched from the first mode to the second mode. That is, the direction control is configured to control a rotation direction of the head of the virtual object at this time. In other words, the player may click/tap the direction control to control the head of the virtual object to rotate in a corresponding direction at this time. If subsequently, a clicking/tapping operation of the player for the mode switching control is received again, the mode of the direction control may be switched from the second mode back to the first mode again. That is, the direction control is configured to control a movement direction of the virtual object at this time. When a clicking operation/tapping operation of the player for the direction control is received, the body of the virtual object may be controlled to rotate in a direction indicated by the clicked/tapped direction control. That is, the movement direction of the virtual object may be controlled to change to the direction indicated by the clicked/tapped direction control. In this way, by reusing the same set of direction controls, interference to the player that is caused by excessive controls presented in a virtual scene picture can be avoided.

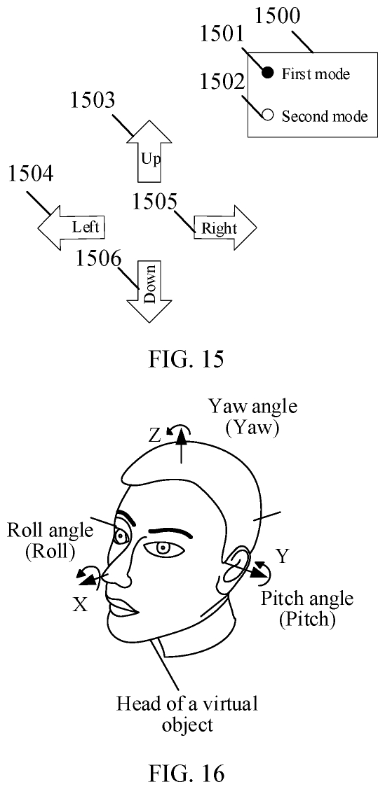

For example, FIG. 15 is a schematic diagram of a direction control according to an example. FIG. 15 shows a layout of the direction control. A mode switching control 1500 includes a mode control 1501 and a mode control 1502. In response to a trigger operation for the mode control 1501, a mode of the direction control is set to the first mode, and in response to a trigger operation for the mode control 1502, the mode of the direction control is set to the second mode. Only one of the mode control 1501 and the mode control 1502 can be triggered at a time. That is, the mode of the direction control is either the first mode or the second mode. A direction control 1503 (up), a direction control 1504 (left), a direction control 1505 (right), and a direction control 1506 (down) are direction indication controls, and are configured to control a movement direction of the virtual object. For example, in the first mode, in response to a trigger operation for the direction control 1505, the body of the virtual object is controlled to rotate in a direction (right) indicated by the clicked/tapped direction control 1505. In the second mode, in response to a trigger operation for the direction control 1505, the head of the virtual object is controlled to rotate in a direction (right) indicated by the clicked/tapped direction control 1505.

In some examples, the direction control configured to control a rotation direction of the head of the virtual object and the direction control configured to control a movement direction of the virtual object may alternatively be two different sets of direction controls. That is, two sets of direction controls may be displayed in the virtual scene. One set of direction controls is configured to control a rotation direction of the head of the virtual object, and the other set of direction controls is configured to control a movement direction of the virtual object. For example, a direction control located on the left side of the virtual scene may be configured to control a movement direction of the virtual object, and a direction control located on the right side of the virtual scene may be configured to control a rotation direction of the head of the virtual object. Alternatively, the player may perform setting according to a habit of the player. For example, the player may set the direction control located at the left side of the virtual scene to be configured to control a rotation direction of the head of the virtual object, and set the direction control located at the right side of the virtual scene to be configured to control a movement direction of the virtual object. This is not specifically limited herein.

A display style of the direction control (such as a direction control 1) configured to control a rotation direction of the head of the virtual object and a display style of the direction control (such as a direction control 2) configured to control a movement direction of the virtual object may be different. For example, the direction control 1 may be displayed in red, and the direction control 2 may be displayed in green, to facilitate differentiation by the user. Alternatively, the display style of the direction control 1 and the display style of the direction control 2 may be the same. For example, corresponding prompt information may be separately displayed near the direction control 1 and the direction control 2, to prompt respective functions of the direction controls. For example, first prompt information indicating that the direction control is configured to control a rotation direction of the head of the virtual object may be displayed near the direction control 1, and second prompt information indicating that the direction control is configured to control a movement direction of the virtual object is displayed near the direction control 2. This is not specifically limited herein.

In some other examples, the press parameters may include a press duration and a press force. In this case, the determining, based on the press parameters, the angle by which the head of the virtual object is to be rotated may be implemented in the following manner: determining a pressure interval of the press force when the press duration is greater than a duration threshold (such as 2 seconds); and using an angle corresponding to the determined pressure interval as the angle by which the head of the virtual object is to be rotated, different pressure intervals corresponding to different angles.

For example, in a mobile device or another interaction terminal device, the press force in the press parameters may be detected in the following manner: directly obtaining a physical pressure value of a press of a user if the device is equipped with a pressure sensor, the physical pressure value being directly proportional to an actual force applied by a finger; or obtaining the press force based on a contact area between the player and a device screen if the device is not equipped with a pressure sensor. For example, a quantity of pixels of a contact area between the finger of the user and the screen is detected through a capacitive screen, the quantity of pixels is converted into the contact area, and the press force is obtained according to a preset mapping relationship between a pressure and an area. The contact area is directly proportional to the press force.

The press duration is detected to avoid that a false touch of the player is identified as a viewing angle rotation operation. To be specific, only when a duration of pressing the direction control by the player is greater than a duration threshold, the press is identified as a viewing angle rotation operation. This can avoid identification of an inadvertent press operation of the player for the direction control as a viewing angle rotation operation.

In some other examples, following the foregoing example, when it is detected that the press force exceeds a preset maximum pressure interval, the following processing may be performed: using an angle corresponding to the maximum pressure interval as the angle by which the head of the virtual object is to be rotated.

For example, four direction controls, namely, up, down, left, and right, may be displayed in the virtual scene. When a press operation of the player on an up direction control is received and a press duration of the press operation exceeds the duration threshold, a press force of the press operation may be obtained. Next, a target pressure interval in which the press force is located may be determined from a plurality of preset pressure intervals. Each pressure interval corresponds to one angle. Subsequently, an angle (such as 30 degrees) corresponding to the target pressure interval may be used as an angle by which the head of the virtual object is to be rotated. Finally, the head of the virtual object may be controlled to rotate upward by 30 degrees. In addition, if it is detected that the press force applied when the player presses the direction control exceeds the maximum pressure interval, an angle corresponding to the maximum pressure interval may be used as an angle by which the head of the virtual object is to be rotated. This can avoid clipping caused by an excessively large rotation angle of the head of the virtual object.

A press operation for a left-right direction control (controlling the head to rotate to the left and right) is used as an example. When a press force falls within an interval of 0 gf to 50 gf (herein, gf (gram-force) represents a gram-force), a corresponding angle is 10°; when the press force falls within an interval of 51 gf to 100 gf, a corresponding angle is 20°; when the press force falls within an interval of 101 gf to 150 gf, a corresponding angle is 30°; and if the press force exceeds 150 gf, that is, falls within the maximum pressure interval, a corresponding angle is 35°.

In the examples described herein, mapping relationships are established between the press duration and the rotation angle of the head of the virtual object, as well as between the press force and the rotation angle of the head of the virtual object. This avoids insufficient control precision caused by a fixed rotation angle. In addition, an abnormal case, such as clipping, that is caused by an extreme operation is controlled and prevented through pressure interval threshold control. This enhances operation immersion, ensures physical realism of the virtual scene, and provides the player with a refined viewing angle control experience.

In some examples, the angle by which the head of the virtual object is to be rotated may be determined based on the duration of pressing the direction control by the player. The angle by which the head of the virtual object is to be rotated may be positively correlated with the duration of pressing the direction control by the player. To be specific, a longer duration of pressing the direction control by the player indicates a larger angle by which the head of the virtual object is to be rotated. For example, it is assumed that it is detected that a duration of pressing an up direction control by the player is 3 seconds. In this case, an angle (which may be, for example, 30 degrees) corresponding to 3 seconds may be queried from a pre-created mapping table. The mapping table may include mapping relationships between different press durations and different angles. Subsequently, the head of the virtual object may be controlled to rotate upward by 30 degrees while keeping the body of the virtual object from rotating. In addition, if it is detected that the duration of pressing the up direction control by the player exceeds the duration threshold, a preset maximum rotatable angle (such as 80 degrees) corresponding to the up direction may be used as an angle by which the head of the virtual object. In other words, even if the duration of pressing the up direction control by the player exceeds the duration threshold, the head of the virtual object is only controlled to rotate upward by 80 degrees. This can avoid clipping caused by an excessively large rotation angle of the head of the virtual object.

That is, to avoid clipping caused by an excessively large rotation angle of the head of the virtual object, before controlling the head of the virtual object to rotate in the direction indicated by the viewing angle rotation operation, the player may further set maximum rotatable rotation angles of the head of the virtual object in different directions. For example, the player may separately set, on a setting interface, maximum rotatable angles of the head of the virtual object in a horizontal direction and a vertical direction. In this way, the rotation angle of the head of the virtual object is limited to avoid clipping.

In the examples described herein, by establishing a positive correlation mapping relationship between the press duration and the rotation angle of the head of the virtual object, and in combination with the limitation of the preset maximum rotatable angle, dynamical matching between the press duration and a rotation amplitude is achieved. This enables the player to precisely control the granularity of viewing angle rotation through the press duration. In addition, clipping in the scene that is caused by excessive rotation is prevented through the angle threshold. This ensures operational flexibility, maintains the physical plausibility of the virtual scene, and provides the player with a viewing angle adjustment experience that combines controllability and realism.

In some examples, the angle by which the head of the virtual object is to be rotated may alternatively be determined through artificial intelligence. In this case, the controlling the head of the virtual object to rotate by a corresponding angle in a direction indicated by the viewing angle rotation operation may further be implemented in the following manner: invoking, based on feature data of the virtual scene (such as a position distribution of other virtual objects in the virtual scene and a type of the virtual scene) and feature data of the virtual object (such as whether the virtual object is in a moving state and whether the virtual object is holding a virtual shooting prop), a machine learning model to perform prediction, to obtain the angle by which the head of the virtual object is to be rotated; and controlling the head of the virtual object to rotate by the determined angle in the direction indicated by the viewing angle rotation operation.

An example in which the virtual object is the game character A controlled by the current player is used. When a viewing angle rotation operation triggered by the player is received, feature data of the game character A and feature data of a game scene in which the game character A is located may be obtained. Next, the feature data of the game character A and the feature data of the game scene may be encoded separately. Subsequently, the encoded feature data (including the feature data of the game character A and the feature data of the game scene) may be inputted into a trained machine learning model for prediction, to obtain an angle (which may be, for example, 20 degrees) by which the head of the game character A is to be rotated. Subsequently, the head of the game character A may be controlled to rotate by 20 degrees in a direction indicated by the viewing angle rotation operation while keeping the body of the game character A from rotating. In this way, the player only needs to determine a rotation direction of the head of the game character, and then the angle by which the head of the game character needs to be rotated may be automatically determined through artificial intelligence based on the feature data of the game character and the feature data of the game scene. This reduces operation load of the player, and further enhances the game experience of the player.

For example, the machine learning model adopts a multi-modality fusion architecture. First, character features (such as a posture and equipment) and scene features (such as a terrain and an obstacle) are separately processed through parallel feature extractors, feature weights are automatically allocated through an attention mechanism, and an interaction relationship between the character features and the scene features is captured, to obtain a fused feature. Then, multi-layer nonlinear transformation is performed on the fused feature. Finally, a predicted value of the rotation angle of the head is outputted through a fully connected layer. Supervised learning may be used in a training phase of the machine learning model. For example, operation data of a professional player is used as a label to optimize a prediction capability of the machine learning model. A specific training method of the machine learning model is not limited herein.

According to the examples described herein, an artificial intelligence technology is introduced. The machine learning model is constructed based on the feature data of the virtual scene and the feature data of the virtual object, to implement intelligent prediction and dynamic adaptation of the rotation angle of the head. A proper rotation amplitude can be automatically generated based on real-time information such as a distribution of other objects in a scene and an action state of the virtual object (such as intelligently adjusting a viewing angle to lock onto an opponent in a battle scene, or maintaining visual balance while moving). In addition, angle control can be made to conform to an operation habit of the player and a scene logic through model training. In this way, the player can obtain an accurate viewing angle feedback without manually adjusting the angle. This greatly reduces operation complexity, and enhances immersion and realism of the virtual scene by using an intelligent interaction logic.

In some other examples, following the foregoing example, before the invoking a machine learning model to perform prediction, the following processing may be further performed: obtaining feature data of a sample virtual scene and feature data of a sample virtual object; invoking, based on the feature data of the sample virtual scene and the feature data of the sample virtual object, an initialized machine learning model to perform prediction, to obtain an angle by which the head of the sample virtual object is to be rotated; determining a difference between the angle by which the head of the sample virtual object is to be rotated and a pre-labeled rotation angle; and performing back propagation based on the difference, and updating parameters of the machine learning model layer by layer during back propagation.

A principle of a back propagation (BP) algorithm is mainly based on a gradient descent method. Weights and parameters of the machine learning model (such as a neural network model) are adjusted by calculating gradients of a loss function with respect to the weights and the parameters, to improve accuracy of neural network model training. A working principle of the algorithm mainly includes the following operations: 1. Forward propagation: Gradually transform input data into a prediction result through a hierarchical structure and parameters of the neural network model, to achieve a complex mapping between inputs and outputs. This operation includes: an input layer receives sample data, a hidden layer receives a signal of a neuron of the input layer and performs weighted summation and bias operations, and finally, an output layer receives a signal from the hidden layer and performs similar weighted summation and bias operations, to obtain a prediction result. 2. Loss calculation: Compare the prediction result with an actual result, and calculate a deviation between the prediction result and the actual result. The deviation is referred to as a loss function or an error function, and represents fitting quality of a model. A smaller value of the loss function indicates higher fitting quality of the model. 3. Back propagation: An error gradient is calculated from the output layer to the input layer by using a chain rule, to efficiently solve for partial derivatives of the parameters of the neural network model and optimize network parameters and minimize the loss function. This operation includes: calculating a gradient of the loss function from the output layer, then back-propagating error information to the hidden layer, and computing an error gradient of each neuron layer by layer. 4. Parameter update: Update weights and the bias parameters in a network by using a gradient descent or another optimization algorithm based on the calculated gradient information, to minimize the loss function. This process is continuously iterated until the value of the loss function reaches a minimum value or a preset quantity of training iterations is reached, at which point training of the neural network model ends.

For example, an exemplary structure of the machine learning model may include: an input layer (namely, an embedding layer), an encoding layer (which may be, for example, formed by a plurality of cascaded convolutional layers), a fully connected layer, and an output layer (including an activation function such as a Softmax function). After the feature data of the sample virtual scene and the feature data of the sample virtual object are obtained, first, the feature data may be inputted into the input layer for embedding. Next, an embedding feature vector outputted by the input layer may be encoded through the encoding layer, to obtain a hidden layer feature vector. Subsequently, the hidden layer feature vector may be fully connected through the fully connected layer. Finally, a fully connected result outputted by the fully connected layer may be inputted into the output layer, and activation is performed through the output layer, to obtain a prediction result (namely, the angle by which the head of the sample virtual object is to be rotated). After the angle by which the head of the sample virtual object is to be rotated outputted by the initialized machine learning model is obtained, the angle by which the head of the sample virtual object is to be rotated and the pre-labeled rotation angle may be substituted into the loss function, to obtain a corresponding difference. Back propagation may be performed based on the difference, and the parameters of the machine learning model may be updated layer by layer during back propagation, to obtain the trained machine learning model.

The machine learning model may be any type of neural network model, for example, including a convolutional neural network model, a deep learning neural network model, and a support vector machine. The type of the machine learning model is not specifically limited herein.

That is, in the examples described herein, the player only needs to determine the rotation direction of the head of the virtual object, and then the angle by which the head of the virtual object is to be rotated can be automatically determined through artificial intelligence. This can reduce operation load of the player, and further enhance the game experience of the player.

In some examples, a shooting game is used as an example. A rotation speed of the head of a game character during rotation may be determined according to a design intention of the game and an operation habit of a player. For example, in the game, a sensitivity coefficient is typically set and a multiplication result of the coefficient and an operation parameter (such as a movement distance of a movement operation, for example, including a slide distance or a drag distance, or a press force of a press operation) of a viewing angle rotation operation may be used as the rotation speed of the head of the game character during rotation. In addition, the player may adjust the sensitivity coefficient according to a preference of the player, to satisfy personalized demands of different players.

A shooting game is used as an example. A basic sensitivity coefficient is automatically adjusted according to a current game scene type (such as a close-quarters street combat or an aiming state), historical operation data of the player is analyzed through machine learning, an operation intention, such as target tracking, quick look around, and precise aiming, is identified, and a speed curve is dynamically optimized. For example, when it is detected that the virtual object (a game human character) controlled by the player continuously moves within a small range, an operation intention is predicted to be target tracking, a speed curve is smoothed, and a maximum value is reduced based on preset parameters. When it is detected that the virtual object controlled by the player quickly slides within a large range, a maximum rotation speed is increased. In addition, the rotation speed may further be determined based on a state of the virtual object controlled by the player. For example, the rotation speed is increased when the virtual object has a small health value.

In some other examples, following the foregoing example, because a frame rate of the game may vary, before the operation parameter of the viewing angle rotation operation is multiplied by the sensitivity coefficient, the operation parameter may further be multiplied by a time parameter, to ensure that the rotation speed of the head of the game character is independent of the frame rate, to keep the rotation speed of the head of the game character consistent across different devices. In addition, to prevent discomfort or a game experience problem caused by an excessively high rotation speed of the head of the game character, a maximum rotatable speed of the head of the game character may further be limited. For example, when a rotation speed set by the player is greater than the maximum rotatable speed, prompt information may be outputted, to prompt the player to make a modification.

In some examples, to make the head of the virtual object rotate smoothly, the head of the virtual object may alternatively be controlled to rotate at a gradual speed. Unity is used as an example. In Unity, a “Mathf.Lerp” function may be used to smoothly transition from one rotation speed to another rotation speed. In addition, in some games, a rotation speed of the head of a game character may alternatively be dynamically adjusted based on a game state or a character state. For example, when the game character is in a special state, the rotation speed of the head of the game character may be decreased or increased.

Transitioning from one rotation speed to another rotation speed through linear interpolation is used as an example. A transition intermediate value result may be calculated by using a formula result=start+t×(end-start) based on a start speed (corresponding to the “one rotation speed”), a target speed (corresponding to the “another rotation speed”), and an interpolation factor t between 0 and 1. The value of t is updated frame by frame, to gradually increase t from 0 to 1. This causes the rotation speed to smoothly transition from the start value to the target value, to form a linear gradient.

Alternatively, the rotation speed of the head of the virtual object may be set by the player. For example, on the setting interface of the game, a corresponding option may be provided for the player to set the rotation speed of the head of the virtual object. This satisfies habits and preferences of different players. The following provides a specific description.

In some examples, a rotation speed setting control may further be displayed in the virtual scene. In this case, before the controlling the head of the virtual object to rotate by a corresponding angle in a direction indicated by the viewing angle rotation operation, the following processing may further be performed: obtaining a set rotation speed in response to a setting operation for the rotation speed setting control. In this case, the controlling the head of the virtual object to rotate by a corresponding angle in a direction indicated by the viewing angle rotation operation may be implemented in the following manner: controlling the head of the virtual object to rotate at the set rotation speed by the corresponding angle in the direction indicated by the viewing angle rotation operation.

An example in which the virtual object is the game character A controlled by the current player is used. The player may set a rotation speed of the game character A. For example, a rotation speed setting control may be displayed in a game scene, and the player may set the rotation speed of the game character A through the rotation speed setting control. For example, it is assumed that the rotation speed set by the player is 1 degree/second. In this case, when the viewing angle rotation operation triggered by the player is received, the head of the game character A may be controlled to rotate at the rotation speed of 1 degree/second by the corresponding angle in the direction indicated by the viewing angle rotation operation. That is, the player may self-define the rotation speed of the head of the game character. This further enhances the game experience of the player.

If the player does not set the rotation speed of the head of the virtual object, the head of the virtual object may be controlled to rotate at a default rotation speed, or the head of the virtual object may be controlled to rotate at a rotation speed previously set by the player. This is not specifically limited herein.

In the examples described herein, by setting the rotation speed adjustment control, the player is granted the authority to self-define the rotation speed of the head of the virtual object. In this way, the player can flexibly adjust the rhythm of viewing angle switching according to an operation habit of the player (such as selecting a high rotation speed in a fast-tempo battle scene and selecting a low rotation speed in a fine exploration scene). Such an adjustable speed control mode not only adapts to the operation preferences of different players but also avoids abrupt viewing angle switching caused by a fixed rotation speed. As a result, the rotation of the head of the virtual object well matches control expectations of the player. This effectively enhances comfort of the interaction process and freedom of scene exploration.

In some other examples, in a process of controlling the head of the virtual object to rotate, the rotation speed of the head of the virtual object may vary. For example, the rotation speed of the head of the virtual object may be fast first and then slow, or may be slow first and then fast. This is not specifically limited herein.

An example in which the virtual object is the game character A controlled by the current player is used. When the viewing angle rotation operation triggered by the player is received, for example, when it is detected that the player presses and holds a middle mouse button and drags a mouse to the left, the body of the game character A may be kept from rotating, and the head of the game character A is controlled to rotate to the left slowly (such as 1 degree/second). When it is detected that the head of the game character A rotates by 50% of the corresponding angle, the head of the game character A may be controlled to rotate to the left rapidly (such as 3 degrees/second). That is, in a process of controlling the head of the game character A to rotate, the rotation speed of the head of the game character A may vary. In this way, a situation in which a person rotates his/her head in the real world can be simulated realistically. That is, a rotation process of the head of the virtual object may be divided into a plurality of phases. In different phases, rotation speeds of the head of the virtual object may be different. For example, the player may set a corresponding rotation speed for each phase, to simulate a head rotation motion realistically.

In some examples, the virtual scene may further include a virtual camera corresponding to the virtual object (such as a virtual camera located at the eyes of the virtual object, which corresponds to a first-person perspective). The first virtual scene picture is obtained by the virtual camera capturing the virtual scene from the first viewing angle. In this case, during the controlling the head of the virtual object to rotate by a corresponding angle in a direction indicated by the viewing angle rotation operation, the following processing may further be performed: controlling the virtual camera to rotate by the corresponding angle in the direction indicated by the viewing angle rotation operation, and capturing the virtual scene through the rotated virtual camera, to obtain the second virtual scene picture. That is, the second virtual scene picture is obtained by the virtual camera capturing the virtual scene from the second viewing angle.

An example in which the virtual object is the game character A controlled by the current player. A virtual camera corresponding to the game character A may be set in the game scene in which the game character A is located. For example, the virtual camera may be set at the eyes of the game character A. In this case, when the head of the game character A is controlled to rotate in the direction indicated by the viewing angle rotation operation, the virtual camera may further be controlled to synchronously rotate in the direction indicated by the viewing angle rotation operation. Subsequently, the game scene may be captured through the rotated virtual camera, to obtain a second game scene picture (that is, the second virtual scene picture).

The following continues to describe a specific implementation process of controlling the head of the virtual object to rotate in the direction indicated by the viewing angle rotation operation.

In some examples, the specific implementation process of controlling the head of the virtual object to rotate may involve a plurality of layers such as input management, physical simulation, an animation system, and a graphics rendering pipeline. The following provides a specific description.

1. Input management: A game engine may capture an input action of a player via a low-level input application programming interface (API), for example, including a press operation for a keyboard or a drag operation for a mouse. The game engine may convert these physical signals into logic signals within a game through an input management system, for example, may convert the drag operation of the player for the mouse into a rotation direction and a rotation angle of the head of a virtual object.

2. Game logic: A game logic layer receives the signals transmitted by the input management system, and determines, according to a game design, how to respond to these signals. In this layer, the rotation direction of the head of the virtual object (such as a game character) may be calculated, and the rotation direction of the head of the virtual object may be typically determined with reference to a current viewing angle of the virtual object, a state of the virtual object, and another logic of the game.

3. Physics engine: If the virtual object (such as the game character) uses the physics engine to performs physical simulation, the physics engine may participate in calculation of head rotation, to ensure that the rotation conforms to a physics rule. For example, the physics engine may simulate muscle strength, joint limitation, and the like of the game character, to make the rotation of the head of the game character realistic.

4. Animation System: The rotation of the head of the game character may be typically implemented through an animation system, for example, may be implemented through a skeleton animation or a vertex animation. For the skeleton animation, the head of the game character includes a series of skeletons, and each skeleton may independently rotate. The animation system may adjust a transform matrix of a related skeleton based on a rotation direction and angle of the head of the game character, to change an orientation of the head of the game character. For the vertex animation, vertex data of the head of the game character may be directly operated, to change the orientation of the head of the game character and then achieve a rotation effect.

5. Rendering pipeline (rendering pipeline): Once the orientation of the head of the game character is calculated by the animation system, the information is transmitted to the rendering pipeline, and the rendering pipeline may calculate, based on a transformation matrix of the head of the game character and other rendering parameters (for example, including a material and lighting), a picture finally displayed on a screen.

The rotation of the head of the game character may be represented by transformation matrices. These matrices may be applied in a vertex shader of the rendering pipeline, to change a position and an orientation of a vertex. To smoothly and precisely rotate the head of a game character in a three-dimensional virtual scene, rotation may be represented by a quaternion. The quaternion can avoid a gimbal lock problem and provide smooth rotation during interpolation. In addition, in the skeleton animation, each vertex may be affected by another skeleton, and an impact of each skeleton may be determined based on a weight of the skeleton. The animation system may blend transformations of different skeletons based on the weights to obtain a final position of the vertex. In the rendering stage, a shader program may use the final position and orientation information of the vertex to determine how to draw the head of the game character, for example, including lighting information and texture mapping.

In some other examples, following the foregoing example, during the controlling the virtual camera to rotate by the angle (namely, the angle by which the head of the virtual object is rotated) in the direction indicated by the viewing angle rotation operation, the following processing may be further performed: controlling shoulders of the virtual object to synchronously retreat by a corresponding distance, the distance being positively correlated with the angle. To be specific, a larger angle by which the virtual camera is rotated indicates a larger distance by which the shoulders of the virtual object retreat.

An example in which the virtual object is the game character A controlled by the current player is used. When the virtual camera (such as the virtual camera set at the eyes of the game character A) corresponding to the game character A is controlled to rotate in the direction indicated by the viewing angle rotation operation, the shoulders of the game character A may further be controlled to synchronously retreat correspondingly. This can avoid clipping between the virtual camera and the shoulder of game character A during rotation of the virtual camera.

In some examples, the virtual scene may further include a setting entry. In this case, before the controlling the head of the virtual object to rotate by a corresponding angle in a direction indicated by the viewing angle rotation operation, the following processing may further be performed: displaying a setting interface in response to a trigger operation for the setting entry. The setting interface may be configured to set maximum rotatable angles respectively corresponding to the head of the virtual object in different directions (including a horizontal direction and a vertical direction) and a rotation speed of the head of the virtual object. In this case, the controlling the head of the virtual object to rotate by a corresponding angle in a direction indicated by the viewing angle rotation operation may be implemented in the following manner: controlling the head of the virtual object to rotate at the rotation speed by the corresponding angle in the direction indicated by the viewing angle rotation operation, the angle being less than or equal to the maximum rotatable angle corresponding to the direction indicated by the viewing angle rotation operation.

A shooting game is used as an example. A setting entry may further be displayed in a game scene. For example, the setting entry may be displayed at an upper right corner of the game scene. When a click/tap operation of the player for the setting entry is received, a setting interface may be displayed as a floating overlay in the game scene. The setting interface may include a plurality of areas for the player to set maximum rotatable angles respectively corresponding to the head of the virtual object in different directions and a rotation speed of the head of the virtual object. For example, the player may set maximum rotatable angles respectively corresponding to the head of the virtual object in a horizontal direction and a vertical direction through the setting interface. For example, a first setting control configured to set the maximum rotatable angle of the head of the virtual object in the horizontal direction, and a second setting control configured to set the maximum rotatable angle of the head of the virtual object in the vertical direction may be displayed on the setting interface. In this way, an angle set by the player in the first setting control may be used as the maximum rotatable angle of the head of the virtual object in the horizontal direction. Similarly, an angle set by the player in the second setting control may be used as the maximum rotatable angle of the head of the virtual object in the vertical direction. In addition, a third setting control configured to set the rotation speed of the head of the virtual object may further be displayed on the setting interface. In this way, a rotation speed set by the player in the third setting control may be used as the rotation speed set for the head of the virtual object. Subsequently, the head of the virtual object is rotated at the rotation speed.

The setting interface may be configured to set the maximum rotatable angles respectively corresponding to the head of the virtual object in different directions and the rotation speed of the head of the virtual object, and may further be configured to set a rotation speed of the virtual camera corresponding to the virtual object and maximum rotatable angles respectively corresponding to the virtual camera in different directions. For example, a fourth setting control configured to set the rotation speed of the virtual camera may further be displayed on the setting interface. In other words, a rotation speed set by the player in the fourth setting control may be used as the rotation speed of the virtual camera. In addition, a fifth setting control configured to set a maximum rotatable angle of the virtual camera in a horizontal direction and a sixth setting control configured to set a maximum rotatable angle of the virtual camera in a vertical direction may further be displayed on the setting interface. In this way, an angle set by the player in the fifth setting control may be used as the maximum rotatable angle of the virtual camera in the horizontal direction. Similarly, an angle set by the player in the sixth setting control may be used as the maximum rotatable angle of the virtual camera in the vertical direction.

In some examples, the virtual object may hold a virtual shooting prop (such as a virtual firearm), and a shooting direction of the virtual shooting prop (such as a muzzle direction of the virtual firearm) may be determined based on the orientation of the body of the virtual object (for example, when the orientation of the body of the virtual object is to the left, the muzzle direction is also to the left). In this case, operation 102 may be implemented in the following manner: keeping, in response to the viewing angle rotation operation, the shooting direction of the virtual shooting prop unchanged (that is, keeping the body of the virtual object from rotating to keep the shooting direction of the virtual shooting prop unchanged), and controlling the head of the virtual object to rotate by the corresponding angle in the direction indicated by the viewing angle rotation operation.

A shooting game is used as an example. A game character (namely the virtual object) displayed in a game scene may hold a virtual shooting prop (such as a virtual firearm). In this case, when a viewing angle rotation operation triggered by a player is received, for example, when it is detected that the player presses and holds a middle mouse key and drags a mouse, a muzzle direction of the virtual firearm held by the game character may be kept unchanged by keeping the body of the game character from rotating, and the head of the game character is controlled to rotate by a corresponding angle in a drag direction. In this way, the directions of the body and the muzzle of the game character unchanged, and surrounding information is obtained only by rotating the head of the game character. Because a range of motion of head rotation is smaller than that of body rotation, the player does not produce any sound to expose himself/herself when controlling the game character to rotate the head. This satisfies requirements of the player for obtaining surrounding information without producing any sound to expose himself/herself, and enhances the game experience of the player.

In some other examples, the player may further control the game character to shoot using the virtual firearm while controlling the game character to rotate the head. In this case, the keeping, in response to the viewing angle rotation operation, the shooting direction of the virtual shooting prop unchanged, and controlling the head of the virtual object to rotate by a corresponding angle in the direction indicated by the viewing angle rotation operation may further be implemented in the following manner: keeping, in response to the viewing angle rotation operation and a shooting operation, the shooting direction of the virtual shooting prop unchanged during the controlling the head of the virtual object to rotate by the corresponding angle in the direction indicated by the viewing angle rotation operation, and controlling the virtual shooting prop to shoot in the shooting direction.

For example, it is assumed that when pressing and holding a middle mouse button and dragging a mouse to the right, the player further presses a fire key (such as an “A” key) on a keyboard. In this case, when the head of the game character is controlled to rotate to the right, the muzzle direction (such as a forward direction) of the virtual firearm held by the game character may be kept unchanged, and the virtual firearm is controlled to shoot forward. That is, the viewing angle of the game character may be different from the muzzle direction of the virtual firearm. When the game character is controlled to rotate the head, the virtual firearm held by the game character may further be controlled to shoot in a previous direction. This can further improve the game experience of the player and game enjoyment. In some examples, the orientation of the body of the virtual object may be configured to determine a movement direction of the virtual object. In this case, operation 102 may further be implemented in the following manner: keeping, in response to receiving the viewing angle rotation operation in a process of controlling the virtual object to move, the movement direction of the virtual object unchanged (that is, the body of the virtual object is not rotated), and controlling the head of the virtual object to rotate by the corresponding angle in the direction indicated by the viewing angle rotation operation.

For example, the keeping, in response to receiving the viewing angle rotation operation in a process of controlling the virtual object to move, the movement direction of the virtual object unchanged, and controlling the head of the virtual object to rotate by the corresponding angle in the direction indicated by the viewing angle rotation operation may be implemented in the following manner: controlling, in response to receiving a movement instruction triggered for the virtual object (for example, receiving a press operation for a “W” key on a keyboard or a click/tap operation for a virtual direction control displayed on a screen), the virtual object to move in a direction indicated by the movement instruction; and keeping, in response to receiving the viewing angle rotation operation (such as an operation of pressing and holding a middle mouse button and dragging a mouse) in a process in which the virtual object moves in the direction indicated by the movement instruction, the movement direction of the virtual object unchanged, and controlling the head of the virtual object to rotate by the corresponding angle in the direction indicated by the viewing angle rotation operation. This can satisfy the requirements of the player for observing the surroundings without changing the movement direction of the game character.

An example in which the virtual object is the game character A controlled by the current player in the game scene is used. In a process of controlling the game character A to move, when the player has the requirements for observing the surroundings without changing a movement direction of the game character A, it may be implemented using the technical solution described herein. For example, when a press operation of the player for a “W” key on a keyboard is received, the game character may be controlled to move forward. It is assumed that a viewing angle rotation operation (such as an operation of pressing and holding a middle mouse button and dragging a mouse) triggered by the player is received in a process of controlling the game character A to move forward, the body of the game character A may be kept from rotating (because the movement direction of the game character A is determined based on an orientation of the body of the game character A, in a case that the body of the game character A is kept from rotating, the movement direction of the game character A also does not change). That is, in a process of keeping the game character A to continue to move forward, the head of the game character A is controlled to rotate by a corresponding angle in a direction indicated by the viewing angle rotation operation. For example, it is assumed that it is detected that the player presses and holds the middle mouse button and drags the mouse by 1 centimeter to the right. In this case, the head of the game character A may be controlled to rotate by 10 degrees to the right. In this way, the player can further control the game character A to turn head to quickly view the surrounding situation while controlling the game character A to quickly dash toward a destination. This enhances the game experience of the player.

Operation 103: Switch to displaying a second virtual scene picture.

Herein, the second virtual scene picture may be obtained by the virtual object observing the virtual scene from a second viewing angle, and the second viewing angle is a viewing angle corresponding to the head of the virtual object after the head of the virtual object is rotated.

In some examples, when a virtual camera bound to the virtual object exists in the virtual scene, for example, when a virtual camera set near the head of the virtual object exists in the virtual scene, the virtual camera bound to the virtual object may further be controlled to synchronously rotate as the head of the virtual object is controlled to rotate. Subsequently, the virtual scene may be captured through the rotated virtual camera, to obtain the second virtual scene picture.

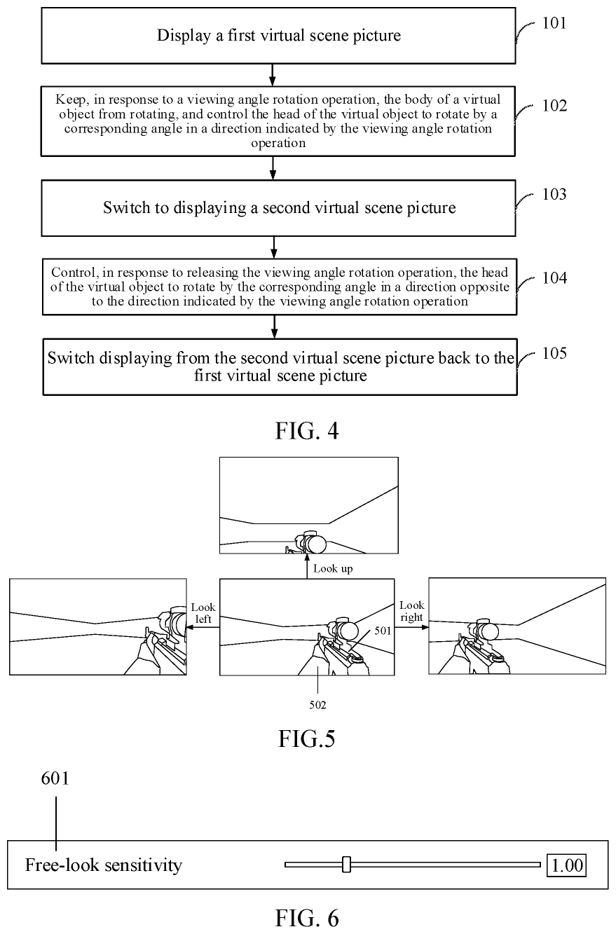

In some other examples, FIG. 4 is a second schematic flowchart of an interaction processing method for a virtual scene according to an example. As shown in FIG. 4, after operation 103 shown in FIG. 3 is performed, operation 104 and operation 105 shown in FIG. 4 may be further performed. A description is made with reference to operations shown in FIG. 4.

Operation 104: Control, in response to releasing the viewing angle rotation operation, the head of the virtual object to rotate by the corresponding angle in a direction opposite to the direction indicated by the viewing angle rotation operation.

In some examples, because the technical solutions described herein are to obtain the surrounding information rather than changing the movement direction of the virtual object, after the surrounding information is obtained, the viewing angle rotation operation is released. An example in which the viewing angle rotation operation is a movement operation (such as an operation of a player pressing and holding a middle mouse button and dragging a mouse to the left) is used. When it is detected that the movement operation is released (for example, the player loosens the hand), the head of the virtual object may be controlled to rotate by the corresponding angle in the direction opposite to the direction indicated by the viewing angle rotation operation (that is, the head of the virtual object may be controlled to return to a neutral position of the head of the virtual object).

For example, when it is detected that the player presses and holds the middle mouse button and drags the mouse by 1 centimeter to the left, in a case that the body of the virtual object (such as the game character A controlled by the current player) is kept from rotating, the head of the game character A may be controlled to rotate by 10 degrees to the left. In this way, the player can observe a situation on a left side of the game character A. Subsequently, when it is detected that the player releases his/her hand, the head of the game character A may be controlled to rotate by 10 degrees to the right, that is, the head of the game character A is controlled to return to a neutral position of the head of the game character A.

For example, when the viewing angle rotation operation is a press operation for a direction control, it is assumed that a press operation of the player for an up direction control displayed in the virtual scene is received, and a press force of the press operation is 10 Newtons. In a case that the body of the virtual object (such as the game character A controlled by the current player) is kept from rotating, the head of the game character A may be controlled to rotate upward by 10 degrees. Subsequently, when it is detected that the player releases his/her hand (that is, the press operation is released), the head of the game character A may be controlled to rotate downward by 10 degrees, that is, the head of the game character A is controlled to return to the neutral position of the head of the game character A.

A rotation speed at which the head of the game character A is rotated to return to the neutral position of the head of the game character A may be the same as or different from a rotation speed at which the head of the game character A is rotated in response to the viewing angle rotation operation. This is not specifically limited herein. For example, the player may separately set, on the setting interface, the rotation speed at which the head of the virtual object is rotated in response to the viewing angle rotation operation and the rotation speed at which the head of the virtual object is rotated in response to releasing the viewing angle rotation operation. Alternatively, a rotation speed set by the player may be used as both the rotation speed at which the head of the virtual object is rotated in response to the viewing angle rotation operation, and the rotation speed at which the head of the virtual object is rotated in response to releasing the viewing angle rotation operation. This is not specifically limited herein.

In some examples, the virtual scene may include a virtual camera corresponding to the virtual object, such as a virtual camera (corresponding to the first-person perspective) set at the eyes of the virtual object. In this case, during the controlling the head of the virtual object to rotate by the corresponding angle in a direction opposite to the direction indicated by the viewing angle rotation operation, the following processing may be further performed: controlling the virtual camera to rotate by a same angle in the direction opposite to the direction indicated by the viewing angle rotation operation.

In some other examples, following the foregoing example, the virtual scene may further include a camera rotation speed setting control. In this case, before the controlling the virtual camera to rotate by a same angle in the direction opposite to the direction indicated by the viewing angle rotation operation, the following processing may further be performed: obtaining, in response to a setting operation for the camera rotation speed setting control, a rotation speed set for the virtual camera. In this case, the controlling the virtual camera to rotate by a same angle in the direction opposite to the direction indicated by the viewing angle rotation operation may be implemented in the following manner: controlling the virtual camera to rotate at the set rotation speed by the same angle in the direction opposite to the direction indicated by the viewing angle rotation operation.

A shooting game is used as an example. A setting control configured to set a rotation speed of a virtual camera (such as a virtual camera set near the head of the game character A) bound to a virtual object (such as the game character A controlled by the current player) may further be displayed in a game scene. The player may set the rotation speed of the virtual camera through the setting control. For example, a rotation speed (such as 4 degrees/second) set by the player in the setting control may be used as the rotation speed of the virtual camera bound to the game character A. In this way, when the virtual camera needs to be rotated, the virtual camera may be controlled to rotate at the rotation speed. For example, when it is detected that the viewing angle rotation operation is released, the virtual camera may be controlled to return to a neutral position of the virtual camera at the rotation speed of 4 degrees/second. This can satisfy personalized demands of different players.

Operation 105: Switch displaying from the second virtual scene picture back to the first virtual scene picture.

In some examples, after the head of the virtual object is controlled to rotate by the same angle in the direction opposite to the direction indicated by the viewing angle rotation operation, the viewing angle of the virtual object changes from the second viewing angle back to the first viewing angle. In this case, the virtual scene image displayed on the human-computer interaction interface may be switched from the second virtual scene picture back to the first virtual scene picture.

An example in which the virtual object is the game character A controlled by the current player is used. A virtual camera bound to the game character A may exist in a game scene. For example, a corresponding virtual camera may be set near the head of the game character A, and the game scene is captured through the virtual camera from a first viewing angle, to obtain a first game scene picture. Next, when a viewing angle rotation operation triggered by a player is received (for example, the player presses and holds a middle mouse button and drags the mouse by 1 centimeter to the right), in a case that the body of the game character A is kept from rotating, the head of the game character A may be controlled to rotate by 10 degrees to the right, and the virtual camera bound to the game character A may be controlled to synchronously rotate by 10 degrees to the right. Subsequently, the game scene may be captured through the rotated virtual camera from a second viewing angle, to obtain a second game scene picture. That is, information on the right side of the game character A may be obtained by controlling the head of the game character A to rotate to the right. Finally, when it is detected that the viewing angle rotation operation is released (for example, it is detected that the player releases his/her hand), the head of the game character A may be controlled to return to a neutral position of the head of the game character A (that is, the head of the game character A is controlled to rotate by 10 degrees to the left), and the virtual camera bound to the game character A is controlled to synchronously return to a neutral position of the virtual camera (that is, the virtual camera is controlled to synchronously rotate by 10 degrees to the left). That is, the viewing angle of the game character A is switched from the second viewing angle back to the first viewing angle. In this case, the game scene picture displayed on the human-computer interaction interface may be switched from the second game scene picture back to the first game scene picture, to keep consistent with the viewing angle of the game character A.

In the interaction processing method for a virtual scene described herein, when the viewing angle rotation operation triggered by the player is received, the body of the virtual object is kept from rotating, and surrounding information is obtained by rotating only the head of the virtual object. Because a range of motion of head rotation is small, no sound is produced. In this way, a silent observation method is provided for the player, which allows the player to choose to obtain surrounding information without producing any sound to expose himself/herself. This enriches tactical options in the virtual scene and enhances the game experience of the player.

The following describes exemplary application of the examples described herein in an actual application scenario by using a first-person shooter (FPS) game as an example.

The interaction processing method for a virtual scene described herein is applicable to the FPS game, to provide a game playing method in which an action of a virtual character turning head to observe the surroundings is simulated in the game. For example, a player may control, by pressing and holding a middle mouse button (namely, a mouse wheel) and dragging the mouse, a virtual camera bound to a game character to view the surroundings, to obtain surrounding information without exposing a sound of the player. In this way, requirements of the player for observing the surroundings without changing a movement direction of a game character when controlling the game character to move can be satisfied. For example, the player can control the game character to turn head to quickly view the surrounding situation while controlling the game character to quickly dash toward a destination. In addition, in the realistic shooting game, the player needs to determine a position of an opponent based on sound information. However, when the game character is controlled to rotate the body and observe a surrounding situation, because a range of motion of body rotation is large, the game character inevitably produces sounds during body rotation, that exposes a position of the game character. In contrast, the present example can provide a silent observation method for the player, which allows the player to choose to obtain limited field-of-view information without producing any sound to expose himself/herself. This enriches tactical options.

Specifically, in the technical solutions described herein, the player may control, by pressing and holding a middle mouse button and dragging a mouse, a virtual camera bound to a game character to view the surroundings, to obtain surrounding information. In addition, to prevent clipping caused by an excessively large observation angle of the player, a range limit may be configured for a rotatable angle. A corresponding three-person (3P) character (namely, a representation of the game character currently controlled by the player as seen from a perspective of another player) may have an animation of head rotation. In this way, the requirements of the player for observing the surroundings without changing a movement direction of the game character when controlling the game character to move can be satisfied. In addition, this enriches tactical options of the game and enhances playability of the game.

The following specifically describes the interaction processing method for a virtual scene described herein.

In some examples, a player may control, by pressing and holding a middle mouse button and dragging a mouse, a virtual camera bound to a game character (such as a virtual camera located near the head of the game character) to rotate and observe a surrounding situation.

For example, FIG. 5 is a schematic diagram of a first application scenario of an interaction processing method for a virtual scene according to an example. As shown in FIG. 5, a game character 502 holding a virtual firearm 501 is displayed in a game scene from the first-person perspective. When it is detected that the player presses and holds the middle mouse button and drag the mouse upward, a virtual camera (not shown in FIG. 5, that is, the virtual camera is invisible to the player, in other words, the virtual camera is not displayed in the game scene) bound to the game character 502 may be controlled to rotate upward. In addition, in a case that the body (namely, the limbs and the torso) of the game character 502 is kept from rotating (in this way, a muzzle of the virtual firearm 501 held by the game character 502 is not rotated), the head of the game character 502 is controlled to rotate upwards (that is, an action of the game character 502 rotating the head to look up is simulated), to observe a situation above the game character 502. When it is detected that the player presses and holds the middle mouse button and drags the mouse to the left, the virtual camera bound to the game character 502 may be controlled to rotate to the left. Meanwhile, in a case that the body of the game character 502 is kept from rotating, the head of the game character 502 may be controlled to rotate to the left (that is, an action of the game character 502 rotating the head to look left is simulated), to observe a situation on the left side of the game character 502. When it is detected that the player presses and holds the middle mouse button and drags the mouse to the right, the virtual camera bound to the game character 502 may be controlled to rotate to the right. Meanwhile, in a case that the body of the game character 502 is kept from rotating, the head of the game character 502 may be controlled to rotate to the right (that is, an action of the game character 502 rotating the head to look right is simulated), to observe a situation on the right side of the game character 502. That is, the player may control, by pressing and holding the middle mouse button and dragging the mouse, the virtual camera bound to the game character to rotate and observe a surrounding situation without producing any sound to expose the player. This enhances the game experience of the player.

In some other examples, a game developer (or a game planner) may configure an observation angle of a game character, for example, may determine the observation angle of the game character based on a rotation angle of a virtual camera. For example, a maximum observable angle of the game character in a vertical upward direction may be 60 degrees, a maximum observable angle of the game character in a vertical downward direction may be 35 degrees, and a maximum observable angle of the game character in a horizontal direction (including horizontal to the left and horizontal to the right) may be ±35 degrees.

The observation angle of the game character does not exceed a maximum rotatable angle of the virtual camera. For example, when a maximum upward rotatable angle of a virtual camera bound to the game character is 90 degrees, that is, the game character has raised the body, and looks up with the muzzle pointing toward the sky, the player presses and holds the middle mouse button and further drags the mouse upward for observation, even after being added with an observation angle contributed by pressing and holding the middle mouse button, the total observation angle does not exceed 90 degrees.

In some examples, the player may further adjust, on a setting interface, a rotation speed of the virtual camera bound to the game character when pressing and holding the middle mouse button and dragging the mouse. This value may be applied to rotation in a horizontal direction and a vertical direction at the same time. Alternatively, the player may separately set the rotation speeds of the virtual camera in the horizontal direction and the vertical direction on the setting interface. For example, there may be two different setting controls on the setting interface, which are separately configured to set the rotation speeds of the virtual camera in the horizontal direction and the vertical direction. This is not specifically limited herein.

For example, FIG. 6 is a schematic diagram of a second application scenario of an interaction processing method for a virtual scene according to an example. As shown in FIG. 6, a free-look sensitivity multiplier setting control 601 may be displayed on the setting interface. The player may set the rotation speed of the virtual camera through the free-look sensitivity multiplier setting control 601. For example, it is assumed that the player sets the multiplier to 1× through the free-look sensitivity multiplier setting control 601. In addition, it is assumed that the player sets the rotation speed of the virtual camera to 2.5 degrees/second. In this case, when player subsequently presses and holds the middle mouse button and drag the mouse, the virtual camera bound to the game character can be controlled to rotate at the rotation speed of 2.5 degrees/second. This can satisfy personalized demands of different players, and further enhance the game experience of the player.

In some other examples, a realistic FPS game is used as an example. A game character controlled by a player exposes sound information all the time in a game scene. Therefore, the player needs to control sound volume of the game character of the player, and may learn information (such as a position) about an opponent (namely, a game character controlled by another player) by listening sounds. In a case that the player intends to obtain more field-of-view information without exposing the player, the player may use the technical solutions described herein to only control the head of the game character to rotate (that is, rotating the head for observation), to obtain limited field-of-view information.

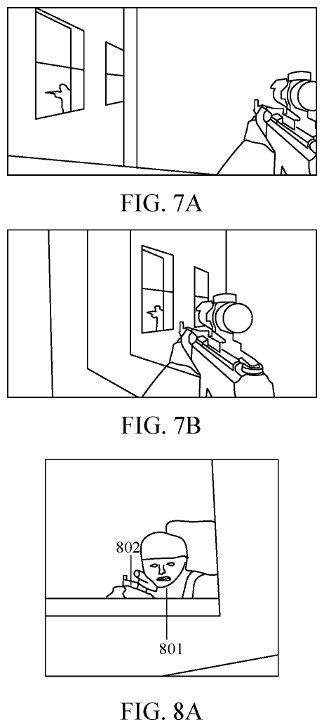

A similar observation behavior involves the player controlling the game character to directly rotate the body and the muzzle for observation (namely, rotating the body for observation). Although the method provides a large observation angle and changes the muzzle orientation, which facilitates timely attacks by the player, the game character inevitably produces sounds when rotating the body, to expose a position of the game character. In other words, rotating the body for observation causes the game character to rotate the entire body, which produces sounds to expose the position of the game character. However, rotating the head for observation does not produce any sound to expose the game character. In this way, the player may freely select different observation manners according to actual situations. For example, when the player does not intend to make any sound to expose the player, the player may obtain limited field-of-view information in a manner of rotating only the head of the game character (such as rotating the head for observation shown in FIG. 7A, in this case, the body of the game character and the muzzle orientation of the held virtual firearm do not rotate). When the player intends to obtain more field-of-view information, the player may use a manner of controlling the game character to directly rotate the body (such as rotating the body for observation shown in FIG. 7B, in this case, the body of the game character and the muzzle orientation of the held virtual firearm are both rotated). This enriches gameplay and enhances the game experience of the player.

The following continues to describe a difference between rotating the body for observation and rotating the head for observation from a viewing angle of another player.

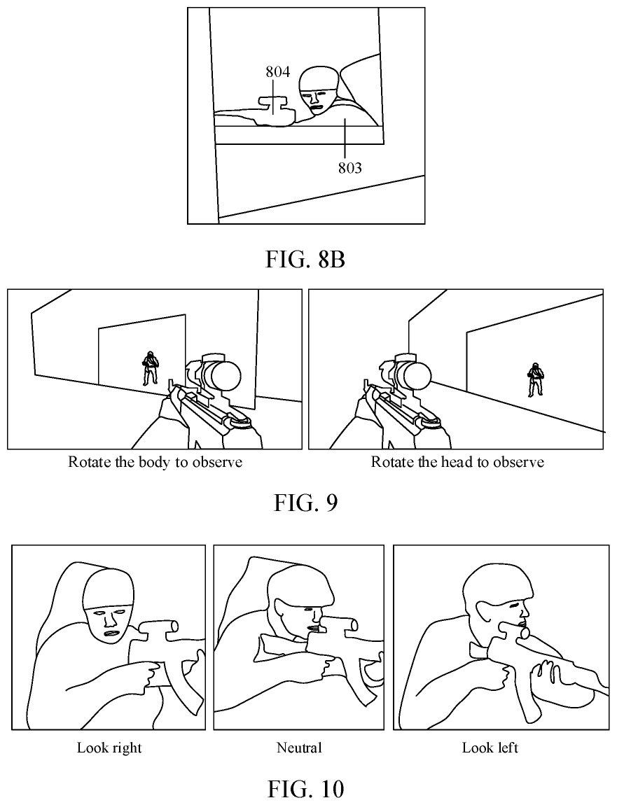

For example, FIG. 8A is a schematic diagram of a fifth application scenario of an interaction processing method for a virtual scene according to an example. As shown in FIG. 8A, rotating the body for observation causes the entire body of a game character 801 to rotate. Because the body of the game character 801 is rotated, a muzzle orientation of a virtual firearm 802 held by the game character 801 is also rotated (that is, another player may see that both the body and the muzzle orientation of the game character currently controlled by the player turn to himself/herself). However, because a range of motion of rotating the body for observation is large, the game character 801 produces a sound to expose himself/herself when rotating the body.

For example, FIG. 8B is a schematic diagram of a sixth application scenario of an interaction processing method for a virtual scene according to an example. As shown in FIG. 8B, rotating the head for observation only causes the head of a game character 803 to rotate. Because the body of the game character 803 is not rotated, a muzzle orientation of a virtual firearm 804 held by the game character 803 does not change, either (that is, another player may see that only the head of the game character currently controlled by the player steers to himself/herself, but the muzzle of the virtual firearm held by the game character does not face himself/herself). Because a range of motion of rotating the head for observation is small, the game character 803 does not produce any sound to expose himself/herself when rotating the head.

In some examples, when controlling the game character to move, the player has the requirements for observing the surroundings without changing a movement direction of the game character. For example, when controlling the game character to quickly dash toward a destination, the player may use the manner of rotating the head for observation described herein to quickly view the surrounding situation. Alternatively, in an indoor environment, when the player intends to control the game character to quickly rush through a gate to observe whether there is anyone inside the gate (that is, a game character controlled by another player), while also avoiding being hit by the game character controlled by the another player because of remaining observation, the player may use the manner of rotating the head for observation described herein to perform a quick check. This increases depth of movement techniques at the operational level.

For example, FIG. 9 is a schematic diagram of comparison between rotating the body for observation and rotating the head for observation according to an example. As shown in FIG. 9, in a process in which a player controls a game character to move, rotating the body for observation requires the game character to completely change a direction to see side information. However, for rotating the head for observation, the side information can be seen without the need for changing a movement direction of the game character.

In some examples, for a game character displayed from the first-person perspective (namely, the 1P perspective), the player may control, by pressing and holding a middle mouse button and dragging a mouse, a virtual camera bound to the game character (such as a virtual camera located near the head of the game character) to rotate and observe a surrounding situation. Because an entire body model of the game character is displayed in a game scene, clipping between the shoulders of the game character and the virtual camera occurs in a process of controlling the virtual camera to rotate. To prevent clipping in the 1P camera, the shoulders of the game character may be controlled to correspondingly retreat while controlling the virtual camera to rotate.

In some other examples, while controlling the virtual camera bound to the first-person perspective of the game character to rotate, a corresponding game character from the third-person perspective (namely, 3P) may further be controlled to perform a corresponding motion of head rotation.

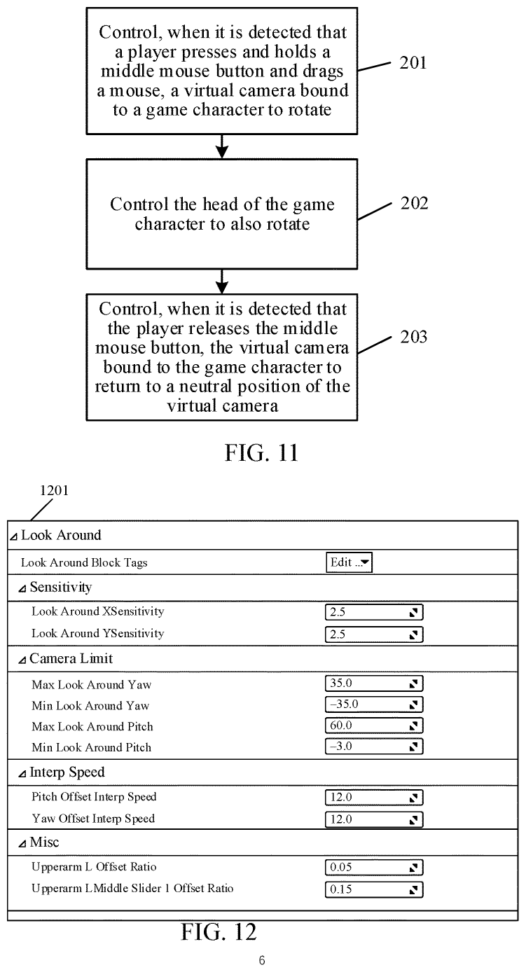

For example, FIG. 10 is a schematic diagram of a seventh application scenario of an interaction processing method for a virtual scene according to an example. As shown in FIG. 10, when it is detected that a player presses and holds a middle mouse button and drags a mouse to the right, while controlling a virtual camera bound to a game character from the 1P perspective to rotate to the right, the head of a game character from the 3P perspective may further be controlled to rotate to the right (that is, another player may see that the game character currently controlled by the player is looking right). When it is detected that the player presses and holds the middle mouse button and drags the mouse to the left, while controlling the virtual camera bound to the game character from the 1P perspective to rotate to the left, the head of the game character from the 3P perspective may further be controlled to rotate to the left (that is, the another player may see that the game character currently controlled by the player is looking left).

Rotating the head for observation does not change an orientation of the body of the game character and an orientation of a muzzle of a held virtual firearm. In other words, the another player may see that only the head of the game character currently controlled by the player is rotated, but the orientation of the body of the game character and the orientation of the muzzle of the held virtual firearm do not change.

The following continues to describe the interaction processing method for a virtual scene described herein with reference to FIG. 11.

For example, FIG. 11 is a third schematic flowchart of an interaction processing method for a virtual scene according to an example. A description is made with reference to operations shown in FIG. 11.

Operation 201: Control, when it is detected that a player presses and holds a middle mouse button and drags a mouse, a virtual camera bound to a game character to rotate.

In some examples, when it is detected that the player presses and holds the middle mouse button and drags the mouse, a virtual camera (namely, a 1P camera) bound to a game character from the first-person perspective may be controlled to rotate. For example, when it is detected that the player presses and holds the middle mouse button and drags the mouse to the left, the virtual camera may be controlled to rotate to the left. In this way, the player may observe a situation on the left side without producing any sound. When it is detected that the player presses and holds the middle mouse button and drags the mouse to the right, the virtual camera may be controlled to rotate to the right. In this way, the player may observe a situation on the right side without producing any sound.

A rotation speed of the virtual camera during rotation may be affected by sensitivity in settings. That is, the player may adjust a sensitivity multiplier on a setting interface to determine a final rotation speed of the virtual camera.

For example, FIG. 12 is a first schematic diagram of a setting interface according to an example. As shown in FIG. 12, when a click/tap operation of a player for a setting entry displayed in a game scene is received, a setting interface 1201 may be displayed in the game scene. “Look Around XSensitivity” indicates rotation sensitivity of a virtual camera bound to a game character in a horizontal direction, and “Look Around YSensitivity” indicates rotation sensitivity of the virtual camera bound to the game character in a vertical direction. The player may further adjust a free-look sensitivity multiplier on the setting interface. In this case, final rotation sensitivity of the virtual camera in the horizontal direction=“Look Around Xsensitivity”×set free-look sensitivity multiplier. For example, it is assumed that “Look Around Xsensitivity” set by the player is 2.5 degrees/cm, and the set sensitivity multiplier is 2×. In this case, the final rotation sensitivity of the virtual camera in the horizontal direction is 5 degrees/cm. That is, the virtual camera is rotated by 5 degrees each time the player moves the mouse by 1 centimeter. Similarly, final rotation sensitivity of the virtual camera in the vertical direction=“Look Around YSensitivity”×set free-look sensitivity multiplier.

In addition, a rotation angle of the virtual camera may be affected by a maximum rotatable angle and an angle of the virtual camera. For example, referring to FIG. 12 again, “Max Look Around Yaw” displayed on the setting interface 1201 indicates a maximum rotatable angle of the virtual camera in the horizontal left direction. “Min Look Around Yaw” indicates a maximum rotatable angle of the virtual camera in a horizontal right direction. “Max Look Around Pitch” indicates a maximum rotatable angle of the virtual camera in a vertical upward direction. “Min Look Around Pitch” indicates a maximum rotatable angle of the virtual camera in a vertical downward direction.

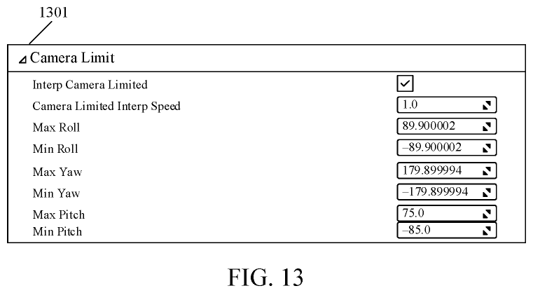

For example, FIG. 13 is a schematic diagram of an angle limitation interface according to an example. As shown in FIG. 13, a virtual camera bound to a game character also has an angle limitation. For example, “Max Yaw” displayed on an angle limitation interface 1301 indicates a maximum rotatable angle of the virtual camera in a horizontal left direction. “Min Yaw” indicates a maximum rotatable angle of the virtual camera in a horizontal right direction. “Max Pitch” indicates a maximum rotatable angle of the virtual camera in a vertical upward direction. “Min Pitch” indicates a maximum rotatable angle of the virtual camera in a vertical downward direction. That is, when a player control, by pressing and holding a middle mouse button and dragging a mouse, the virtual camera bound to the game character to rotate, a rotation angle does not exceed angle values of Yaw and Pitch shown in FIG. 13. That is, the maximum rotatable angles in the horizontal direction are ±180 degrees, the maximum rotatable angle in the vertical upward direction are 75 degrees, and the maximum rotatable angle in the vertical downward direction is −85 degrees.

Operation 202: Control the head of the game character to also rotate.

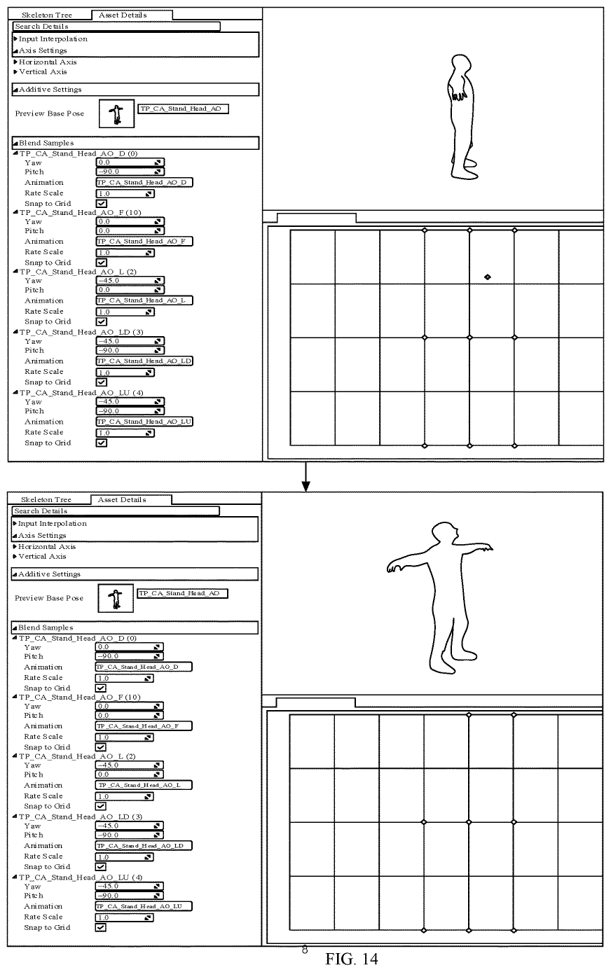

In some examples, FIG. 14 is a second schematic diagram of a setting interface according to an example. As shown in FIG. 14, there are nine animations in a mixed space, which respectively represent head rotation actions corresponding to a neutral position, horizontal yaw of ±45 degrees, and vertical pitch of ±90 degrees. For example, a point 1401 at an upper left corner indicates an action of the game character looking upward by 90 degrees while looking leftward by 45 degrees. When a 1P camera is rotated by a corresponding angle, the head of a 3P character (that is, a game character from the third-person perspective) is superimposed with an animation of this rotation. This make the representation of the game character realistic. That is, while controlling the virtual camera corresponding to the 1P perspective to rotate, another player may see that the head of the game character also rotates correspondingly. For example, when the virtual camera is controlled to rotate to the left, the another player may see that the head of the game character is also rotated to the left.

Operation 203: Control, when it is detected that the player releases the middle mouse button, the virtual camera bound to the game character to return to a neutral position of the virtual camera.

In some examples, before performing operation 203, the player may further set, on the setting interface, a return speed (Interp Speed) of the virtual camera. For example, still referring to FIG. 12, “Pitch Offset Interp Speed” displayed on the setting interface 1201 indicates a return speed of the virtual camera in a vertical direction during returning to the neutral position, and “Yaw Offset Interp Speed” indicates a return speed of the virtual camera in a horizontal direction during returning to the neutral position. Subsequently, when it is detected that the player releases the middle mouse button, the virtual camera may be controlled to return to the neutral position at the returning speed set by the player on the setting interface.

While controlling the virtual camera bound to the game character to return to the neutral position, the head of the game character may be controlled to return to a neutral position. For example, the player may further set a return speed of the head of the game character on the setting interface, for example, including a return speed of the head of the game character in a horizontal direction and a return speed of the head of the game character in a vertical direction. Subsequently, when it is detected that the player releases the middle mouse button, the head of the game character may be controlled to return to the neutral position at the return speed that is set by the player for the head of the game character on the setting interface.

In conclusion, the interaction processing method for a virtual scene described herein has the following beneficial effects:
1. The player can observe an environment within the game without exposing any sound, which increases options of observation manners and enriches strategic depth of the game.
2. The player can observe the surrounding environment without changing the movement direction of the game character, and the method is applicable to application scenarios such as outdoor observation and indoor battling, which enriches operation skills of the game and enhances the game experience of the player.

The following continues to describe an exemplary structure of the interaction processing apparatus 555 for a virtual scene described herein that is implemented as software modules. In some examples, as shown in FIG. 2, the software modules of the interaction processing apparatus 555 for a virtual scene stored in the memory 550 may include: a display module 5551 and a control module 5552.

The display module 5551 is configured to display a first virtual scene picture, the first virtual scene picture being obtained by a virtual object observing a virtual scene from a first viewing angle. The control module 5552 is configured to keep, in response to a viewing angle rotation operation, the body of the virtual object from rotating, and control the head of the virtual object to rotate by a corresponding angle in a direction indicated by the viewing angle rotation operation. The display module 5551 is further configured to switch to displaying a second virtual scene picture, the second virtual scene picture being obtained by the virtual object observing the virtual scene from a second viewing angle, and the second viewing angle being a viewing angle corresponding to the head of the virtual object after the head of the virtual object is rotated.

In some examples, the viewing angle rotation operation includes a movement operation. The movement operation includes a slide operation and a drag operation. The interaction processing apparatus 555 for a virtual scene further includes an obtaining module 5553 and a determining module 5554. The obtaining module 5553 is configured to obtain a movement distance of the movement operation. The determining module 5554 is configured to determine, based on the movement distance, an angle by which the head of the virtual object is to be rotated, the angle being positively correlated with the movement distance. The control module 5552 is configured to control the head of the virtual object to rotate by the angle in a movement direction of the movement operation.

In some examples, the determining module 5554 is further configured to query a mapping table based on the movement distance when the movement distance is less than a distance threshold, to obtain the angle by which the head of the virtual object is to be rotated, the mapping table including mapping relationships between different movement distances and different angles; or configured to use, when the movement distance is greater than the distance threshold, a preset maximum rotatable angle as the angle by which the head of the virtual object is to be rotated.

In some examples, the virtual scene includes at least one direction control, and the viewing angle rotation operation includes a press operation for any direction control. The obtaining module 5553 is further configured to obtain press parameters of the press operation. The determining module 5554 is further configured to determine, based on the press parameters, the angle by which the head of the virtual object is to be rotated. The control module 5552 is further configured to control the head of the virtual object to rotate by the angle in a direction indicated by the pressed direction control.

In some examples, the press parameters include a press duration and a press force. The determining module 5554 is further configured to determine a pressure interval of the press force when the press duration is greater than a duration threshold; and use an angle corresponding to the pressure interval as the angle by which the head of the virtual object is to be rotated, different pressure intervals corresponding to different angles.

In some examples, the determining module 5554 is further configured to use, when the press force exceeds a preset maximum pressure interval, an angle corresponding to the maximum pressure interval as the angle by which the head of the virtual object is to be rotated.

In some examples, the interaction processing apparatus 555 for a virtual scene further includes a prediction module 5555, configured to invoke, based on feature data of the virtual scene and feature data of the virtual object, a machine learning model to perform prediction, to obtain the angle by which the head of the virtual object is to be rotated. The control module 5552 is further configured to control the head of the virtual object to rotate by the angle in the direction indicated by the viewing angle rotation operation.

In some examples, the interaction processing apparatus 555 for a virtual scene further includes a training module 5556, configured to obtain feature data of a sample virtual scene and feature data of a sample virtual object; invoke, based on the feature data of the sample virtual scene and the feature data of the sample virtual object, an initialized machine learning model to perform prediction, to obtain an angle by which the head of the sample virtual object is to be rotated; determine a difference between the angle by which the head of the sample virtual object is to be rotated and a pre-labeled rotation angle; and perform back propagation based on the difference, and update parameters of the machine learning model layer by layer during back propagation.

In some examples, the virtual scene includes a rotation speed setting control. The obtaining module 5553 is further configured to obtain a set rotation speed in response to a setting operation for the rotation speed setting control. The control module 5552 is further configured to control the head of the virtual object to rotate at the set rotation speed by the corresponding angle in the direction indicated by the viewing angle rotation operation.

In some examples, the virtual scene includes a virtual camera corresponding to the virtual object, and the first virtual scene picture is obtained by the virtual camera capturing the virtual scene from the first viewing angle. The control module 5552 is further configured to control the virtual camera to rotate by the angle in the direction indicated by the viewing angle rotation operation during the controlling the head of the virtual object to rotate by a corresponding angle in a direction indicated by the viewing angle rotation operation, the second virtual scene picture being obtained by the virtual camera capturing the virtual scene from the second viewing angle.

In some examples, the control module 5552 is further configured to control the shoulders of the virtual object to synchronously retreat by a corresponding distance during the controlling the virtual camera to rotate by an angle in a direction indicated by the viewing angle rotation operation, the distance being positively correlated with the angle.

In some examples, the control module 5552 is further configured to control, in response to releasing the viewing angle rotation operation, the head of the virtual object to rotate by the angle in a direction opposite to the direction indicated by the viewing angle rotation operation, and switch displaying from the second virtual scene picture back to the first virtual scene picture.

In some examples, the virtual scene includes a virtual camera corresponding to the virtual object. The control module 5552 is further configured to control the virtual camera to rotate by the angle in the direction opposite to the direction indicated by the viewing angle rotation operation during the controlling the head of the virtual object to rotate by the angle in a direction opposite to the direction indicated by the viewing angle rotation operation.

In some examples, the virtual scene further includes a camera rotation speed setting control. The obtaining module 5553 is further configured to obtain, in response to a setting operation for the camera rotation speed setting control, a rotation speed set for the virtual camera. The control module 5552 is further configured to control the virtual camera to rotate at the rotation speed by the angle in the direction opposite to the direction indicated by the viewing angle rotation operation.

In some examples, the virtual scene includes a setting entry. The display module 5551 is further configured to display a setting interface in response to a trigger operation for the setting entry, the setting interface being configured to set maximum rotatable angles respectively corresponding to the head of the virtual object in different directions and a rotation speed of the head of the virtual object. The control module 5552 is further configured to control the head of the virtual object to rotate at the rotation speed by the corresponding angle in the direction indicated by the viewing angle rotation operation, the angle is less than or equal to the maximum rotatable angle corresponding to the direction.

In some examples, the virtual object holds a virtual shooting prop. The control module 5552 is further configured to keep, in response to the viewing angle rotation operation, the body of the virtual object from rotating and the shooting direction of the virtual shooting prop unchanged, and control the head of the virtual object to rotate by the corresponding angle in the direction indicated by the viewing angle rotation operation.

In some examples, an orientation of the body of the virtual object is configured to determine a movement direction of the virtual object. The control module 5552 is further configured to keep, in response to receiving the viewing angle rotation operation in a process of controlling the virtual object to move, the movement direction of the virtual object unchanged, and control the head of the virtual object to rotate by the corresponding angle in direction indicated by the viewing angle rotation operation.

The description of the apparatus examples is similar to the description of the foregoing method examples. The apparatus examples have beneficial effects similar to those of the method examples. Details are not described again. For technical details of the interaction processing apparatus for a virtual scene described herein that are not fully described, refer to the description of any one of FIG. 3 and FIG. 4 for understanding.

Described herein is a computer program product. The computer program product includes a computer program or computer-executable instructions. The computer program or the computer-executable instructions are stored in a computer-readable storage medium. A processor of a computer device reads the computer-executable instructions from the computer-readable storage medium, and executes the computer-executable instructions, to cause the computer device to perform the interaction processing method for a virtual scene described herein.

Described herein is a non-transitory computer-readable storage medium having computer-executable instructions stored therein. The computer-executable instructions, when executed by a processor, cause the processor to perform the interaction processing method for a virtual scene described herein, such as the interaction processing method for a virtual scene shown in FIG. 3 or FIG. 4.

In some examples, the computer-readable storage medium may be a memory such as a ferroelectric random-access memory (FRAM), a ROM, a programmable read-only memory (PROM), an erasable programmable read-only memory (EPROM), an electrically erasable programmable read-only memory (EEPROM), a flash memory, a magnetic surface memory, a compact disc, and a compact disc read-only memory (CD-ROM). Alternatively, the computer-readable storage medium may be any device including one of or any combination of the foregoing memories.

In some examples, the executable instructions may take the form of a program, software, a software module, a script, or code, and may be written in any form of programming language (including compiled or interpreted languages, or declarative or procedural languages). In addition, the executable instructions may be deployed in any form, including being deployed as a standalone program or as a module, component, subroutine, or another unit suitable for use in a computing environment.

As an example, the executable instructions may be deployed on a same electronic device for execution, or executed on a plurality of electronic devices located at a same position, or executed on a plurality of electronic devices distributed at a plurality of positions and interconnected via a communications network.

The above are merely examples, and are not intended to limit the scope of protection of this application. Any modification, equivalent replacement, improvement, and the like made within the spirit and scope of this application fall within the scope of protection of this application.

What is claimed is:

1. An interaction processing method for a virtual scene, performed by an electronic device and comprising:
displaying a first virtual scene picture, the first virtual scene picture being obtained by a virtual object observing a virtual scene from a first viewing angle;
in response to a viewing angle rotation operation indicating a direction, keeping a body of the virtual object from rotating and controlling a head of the virtual object to rotate by a corresponding angle in the direction indicated by the viewing angle rotation operation; and
switching to displaying a second virtual scene picture, the second virtual scene picture being obtained by the virtual object observing the virtual scene from a second viewing angle, and the second viewing angle corresponding to the head of the virtual object after the head of the virtual object is rotated.

2. The method according to claim 1, wherein:
the viewing angle rotation operation comprises a movement operation, and the movement operation comprises a slide operation and a drag operation; and
the controlling the head of the virtual object to rotate comprises:
obtaining a movement distance of the movement operation;
determining, based on the movement distance, an angle by which the head of the virtual object is to be rotated, the angle being positively correlated with the movement distance; and
controlling the head of the virtual object to rotate by the angle in a movement direction of the movement operation.

3. The method according to claim 2, wherein the determining, based on the movement distance, the angle by which the head of the virtual object is to be rotated comprises:
querying a mapping table based on the movement distance in response to the movement distance being less than a distance threshold, to obtain the angle by which the head of the virtual object is to be rotated, the mapping table comprising mapping relationships between different movement distances and different angles; or
using, in response to the movement distance being greater than the distance threshold, a preset maximum rotatable angle as the angle by which the head of the virtual object is to be rotated.

4. The method according to claim 1, wherein:
the virtual scene comprises at least one direction control, and the viewing angle rotation operation comprises a press operation for a direction control of the at least one direction control; and
the controlling the head of the virtual object to rotate comprises:
obtaining press parameters of the press operation;
determining, based on the press parameters, the angle by which the head of the virtual object is to be rotated; and
controlling the head of the virtual object to rotate by the angle in a direction indicated by the pressed direction control.

5. The method according to claim 4, wherein:
the press parameters comprise a press duration and a press force; and
the determining, based on the press parameters, the angle by which the head of the virtual object is to be rotated comprises:
determining a pressure interval of the press force when the press duration is greater than a duration threshold; and
using an angle corresponding to the pressure interval as the angle by which the head of the virtual object is to be rotated, different pressure intervals corresponding to different angles.

6. The method according to claim 5, further comprising:
using, when the press force exceeds a preset maximum pressure interval, an angle corresponding to the maximum pressure interval as the angle by which the head of the virtual object is to be rotated.

7. The method according to claim 4, wherein:
the press parameters comprise a press duration; and
the determining, based on the press parameters, the angle by which the head of the virtual object is to be rotated comprises:
querying a preset mapping table based on the press duration, to obtain the angle by which the head of the virtual object is to be rotated, the mapping table comprising mapping relationships between different press durations and different angles, and the angle being positively correlated with the press duration.

8. The method according to claim 7, further comprising:
using, when the press duration is greater than a preset duration threshold, an angle corresponding to the duration threshold as the angle by which the head of the virtual object is to be rotated.

9. The method according to claim 1, wherein the controlling the head of the virtual object to rotate comprises:
invoking a machine learning model based on feature data of the virtual scene and feature data of the virtual object to perform prediction, to obtain the angle by which the head of the virtual object is to be rotated; and
controlling the head of the virtual object to rotate by the angle in the direction indicated by the viewing angle rotation operation.

10. The method according to claim 1, further comprising:
obtaining feature data of a sample virtual scene and feature data of a sample virtual object;
invoking, based on the feature data of the sample virtual scene and the feature data of the sample virtual object, an initialized machine learning model to perform prediction, to obtain an angle by which the head of the sample virtual object is to be rotated;
determining a difference between the angle by which the head of the sample virtual object is to be rotated and a pre-labeled rotation angle; and
performing back propagation based on the difference, and updating parameters of the machine learning model layer by layer during back propagation.

11. The method according to claim 1, wherein:
the virtual scene comprises a rotation speed setting control; and
the method further comprises:
obtaining a set rotation speed in response to a setting operation for the rotation speed setting control; and
the controlling the head of the virtual object to rotate comprises:
controlling the head of the virtual object to rotate at the set rotation speed by the corresponding angle in the direction indicated by the viewing angle rotation operation.

12. The method according to claim 1, wherein the method further comprises:
controlling shoulders of the virtual object to synchronously retreat by a corresponding distance, the distance being positively correlated with the angle.

13. The method according to claim 1, after the switching to displaying the second virtual scene picture, the method further comprises:
controlling, in response to releasing the viewing angle rotation operation, the head of the virtual object to rotate by the angle in a direction opposite to the direction indicated by the viewing angle rotation operation, and switching displaying from the second virtual scene picture back to the first virtual scene picture.

14. The method according to claim 1, wherein:
the virtual scene comprises a setting entry; and
the method further comprises:
displaying a setting interface in response to a trigger operation for the setting entry, the setting interface being configured to set maximum rotatable angles respectively corresponding to the head of the virtual object in different directions and a rotation speed of the head of the virtual object; and
the controlling the head of the virtual object to rotate comprises:
controlling the head of the virtual object to rotate at the rotation speed by the corresponding angle in the direction indicated by the viewing angle rotation operation, the angle being less than or equal to the maximum rotatable angle corresponding to the direction.

15. The method according to claim 1, wherein:
the virtual object holds a virtual shooting prop, and an orientation of the body of the virtual object is configured for determining a shooting direction of the virtual shooting prop;
the keeping the body of the virtual object from rotating comprises in response to the viewing angle rotation operation, keeping the shooting direction of the virtual shooting prop unchanged; and
the controlling the head of the virtual object to rotate comprises controlling the head of the virtual object to rotate by the corresponding angle in the direction indicated by the viewing angle rotation operation.

16. The method according to claim 1, wherein:
an orientation of the body of the virtual object is configured for determining a movement direction of the virtual object;
the keeping the body of the virtual object from rotating comprises keeping, in response to receiving the viewing angle rotation operation in a process of controlling the virtual object to move, the movement direction of the virtual object unchanged; and
the controlling the head of the virtual object to rotate comprises: controlling the head of the virtual object to rotate by the corresponding angle in the direction indicated by the viewing angle rotation operation.

17. An interaction processing apparatus for a virtual scene, comprising:
one or more processors; and
memory storing instructions that, when executed by the one or more processors; cause the apparatus to:
display a first virtual scene picture, the first virtual scene picture being obtained by a virtual object observing a virtual scene from a first viewing angle;
in response to a viewing angle rotation operation indicating a direction, keep a body of the virtual object from rotating and controlling a head of the virtual object to rotate by a corresponding angle in the direction indicated by the viewing angle rotation operation; and
switch to displaying a second virtual scene picture, the second virtual scene picture being obtained by the virtual object observing the virtual scene from a second viewing angle, and the second viewing angle corresponding to the head of the virtual object after the head of the virtual object is rotated.

18. The interaction processing apparatus of claim 17, wherein the viewing angle rotation operation comprises a movement operation, and the movement operation comprises a slide operation and a drag operation; and
the instructions, when executed by the one or more processors, cause the apparatus to control the head of the virtual object to rotate by:
obtaining a movement distance of the movement operation;
determining, based on the movement distance, an angle by which the head of the virtual object is to be rotated, the angle being positively correlated with the movement distance; and
controlling the head of the virtual object to rotate by the angle in a movement direction of the movement operation.

19. A non-transitory computer-readable medium storing instructions that, when executed, cause:
displaying a first virtual scene picture, the first virtual scene picture being obtained by a virtual object observing a virtual scene from a first viewing angle;
in response to a viewing angle rotation operation indicating a direction, keeping a body of the virtual object from rotating and controlling a head of the virtual object to rotate by a corresponding angle in the direction indicated by the viewing angle rotation operation; and
switching to displaying a second virtual scene picture, the second virtual scene picture being obtained by the virtual object observing the virtual scene from a second viewing angle, and the second viewing angle corresponding to the head of the virtual object after the head of the virtual object is rotated.

20. The non-transitory computer-readable medium according to claim 19, wherein the viewing angle rotation operation comprises a movement operation, and the movement operation comprises a slide operation and a drag operation, and
the instructions, when executed, cause the controlling the head of the virtual object to rotate by:
obtaining a movement distance of the movement operation;
determining, based on the movement distance, an angle by which the head of the virtual object is to be rotated, the angle being positively correlated with the movement distance; and
controlling the head of the virtual object to rotate by the angle in a movement direction of the movement operation.
